(19) United States
(12) Patent Application Publication
(10) Pub. No.: US 2018/0120934 A1
(43) Pub. Date: May 3, 2018

(54) NON-TRANSITORY COMPUTER-READABLE STORAGE MEDIUM, CALIBRATION DEVICE, AND CALIBRATION METHOD

(71) Applicant: FUJITSU LIMITED, Kawasaki-shi (JP)

(72) Inventor: Akinori Taguchi, Kawasaki (JP)

(73) Assignee: FUJITSU LIMITED, Kawasaki-shi (JP)

(21) Appl. No.: 15/798,010

(22) Filed: Oct. 30, 2017

(30) Foreign Application Priority Data
Nov. 1, 2016 (JP) 2016-214544

(51) Int. Cl. G06F 3/01; G06F 3/0488

(52) U.S. Cl. CPC G06F 3/013; G06F 3/0488; G06F 3/04883

(57) ABSTRACT

A non-transitory computer-readable storage medium storing a calibration program that causes the computer to execute a process, the process including, detecting an operation of a user for a display screen of an information processing device, determining whether the detected operation corresponds to a predetermined operation stored in a memory, the predetermined operation being an operation that designates a display position with a predetermined condition, detecting a display position in the display screen designated by the detected operation, and detecting a gaze position of the user by using a sensor in a case where the detected operation corresponds to the predetermined operation pattern stored in the memory, associating the detected gaze position detected at a specified timing with the detected display position detected at the specified timing, and calibrating a gaze position to be detected by the sensor, based on the associated display position and the associated gaze position.

### CROSS-REFERENCE TO RELATED APPLICATION

This application is based upon and claims the benefit of priority of the prior Japanese Patent Application No. 2016-214544, filed on Nov. 1, 2016, the entire contents of which are incorporated herein by reference.

### FIELD

The embodiments discussed herein are related to a non-transitory computer-readable storage medium, a calibration device, and a calibration method.

### BACKGROUND

There is known an information processing apparatus that allows line-of-sight calibration to be executed without specific knowledge of the user. The information processing apparatus detects an operation of an operator on an object, which is displayed on a display screen and is intended to execute a predetermined input. Then, the information processing apparatus detects the movement of the line of sight of the operator directed to the display screen. Then, based on the movement of the line of sight detected during the operation of the operator on the object, the information processing apparatus acquires the correction coefficient for correcting the error in a case where the operator performs the line-of-sight input.

Japanese Laid-open Patent Publication No. 2015-152939 is example of the related art.

### SUMMARY

According to an aspect of the invention, a non-transitory computer-readable medium storing a calibration program that causes the computer to execute a process, the process including, detecting an operation of a user for a display screen of an information processing device, determining whether the detected operation corresponds to a predetermined operation stored in a memory, the predetermined operation being an operation that designates a display position with a predetermined condition, detecting a display position in the display screen designated by the detected operation, and detecting a gaze position of the user by using a sensor in a case where the detected operation corresponds to the predetermined operation pattern stored in the memory, associating the detected gaze position detected at a specified timing with the detected display position detected at the specified timing, and calibrating a gaze position to be detected by the sensor, based on the associated display position and the associated gaze position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic block diagram of an information processing terminal according to a first embodiment;

FIG. 2 is an explanatory diagram for explaining a method of using the information processing terminal according to the first embodiment;

FIG. 3 is a diagram illustrating an example of parameters for detecting the line of sight of the user;

FIG. 4 is a diagram illustrating an example of an operation pattern according to the first embodiment;

FIG. 5 is an explanatory diagram for explaining an input operation through a touch panel;

FIG. 6 is a diagram illustrating an example of calibration data according to the first embodiment;

FIG. 7 is a block diagram illustrating a schematic configuration of a computer functioning as the information processing terminal according to the first embodiment;

FIG. 8 is a flowchart illustrating an example of a calibration process according to the first embodiment;

FIG. 9 is a schematic block diagram of an information processing terminal according to a second embodiment;

FIG. 10 is an explanatory diagram for explaining a method of using the information processing terminal according to the second embodiment;

FIG. 11 is an explanatory diagram for explaining a case where a user wears the information processing terminal and can proceed with a work with reference to a manual displayed on the information processing terminal;

FIG. 12 is a diagram illustrating an example of an operation pattern according to the second embodiment;

FIG. 13 is a flowchart illustrating an example of a calibration process according to the second embodiment;

FIG. 14 is a schematic block diagram of an information processing terminal according to a third embodiment;

FIG. 15 is a diagram illustrating an example of an operation pattern according to the third embodiment;

FIG. 16 is an explanatory diagram for explaining an example in which the user performs finger pointing checking and proceeds with a work;

FIG. 17 is a flowchart illustrating an example of a calibration process according to the third embodiment;

FIG. 18 is a schematic block diagram of an information processing terminal according to a fourth embodiment;

FIG. 19 is a diagram illustrating an example of an operation pattern related to the operation sequence according to the fourth embodiment;

FIG. 20 is a diagram illustrating an example of a carefulness degree set in response to an operation by a user;

FIG. 21 is a diagram illustrating an example of calibration data according to the fourth embodiment;

FIG. 22 is a block diagram illustrating a schematic configuration of a computer functioning as the information processing terminal according to the fourth embodiment;

FIG. 23 is a flowchart illustrating an example of a calibration process according to the fourth embodiment;

FIG. 24 is a schematic block diagram of an information processing terminal according to a fifth embodiment;

FIG. 25 is a block diagram illustrating a schematic configuration of a computer functioning as the information processing terminal according to the fifth embodiment;

FIG. 26 is a flowchart illustrating an example of a calibration process according to the fifth embodiment;

FIG. 27 is a schematic block diagram of an information processing terminal according to a sixth embodiment;

FIG. 28 is a block diagram illustrating a schematic configuration of a computer functioning as the information processing terminal according to the sixth embodiment;

FIG. 29 is a flowchart illustrating an example of a calibration data acquisition process according to the sixth embodiment; and

FIG. 30 is a flowchart illustrating an example of a calibration process according to the sixth embodiment.

### DESCRIPTION OF EMBODIMENTS

However, for example, if the calibration is executed based on the line of sight detected when an erroneous operation is performed by the operator, it is not possible to accurately execute the calibration for the detection process of the line of sight of the user.

In an aspect, the object of the present disclosure is to accurately execute the calibration for the detection process of the line of sight of the user.

Hereinafter, an example of embodiments of the disclosed technique will be described in detail with reference to the drawings.

### First Embodiment

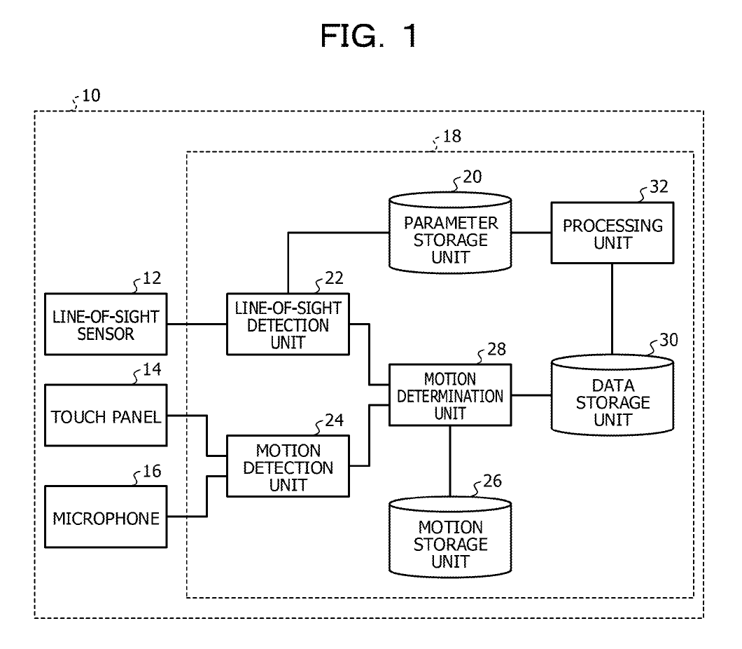

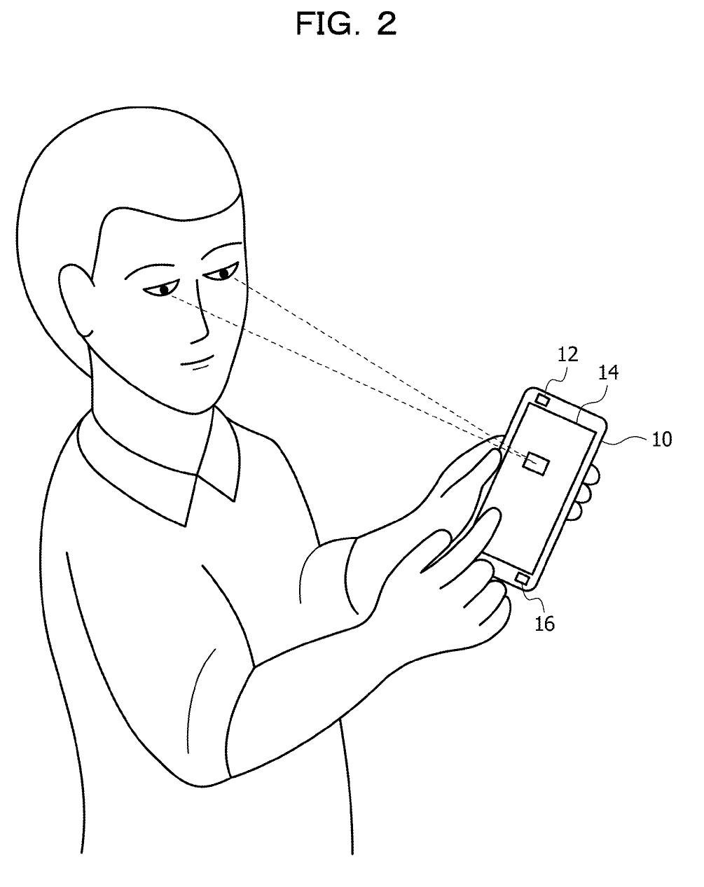

The information processing terminal 10 illustrated in FIG. 1 includes a line-of-sight sensor 12, a touch panel 14, a microphone 16, and a calibration unit 18. The information processing terminal 10 receives an input operation from the user and performs an information process according to the input operation. In the first embodiment, for example, as illustrated in FIG. 2, a case will be described as an example in which a calibration process for the detection process of the line of sight of the user is performed in a scene where the user operates the information processing terminal 10 capable of receiving an input operation with the touch panel 14. The information processing terminal is realized by, for example, a smartphone or the like. In addition, the information processing terminal may be a terminal installed in a public facility, a transportation facility, a store, and the like, and may be realized by a terminal or the like used by an unspecified number of users when receiving an offer of services by a touch panel operation. The calibration unit 18 is an example of the calibration device which is a disclosed technique.

The line-of-sight sensor 12 detects the line-of-sight information of the user. For example, the line-of-sight sensor 12 detects an image of an area including both eyes of the user as line-of-sight information. For example, as illustrated in FIG. 2, the line-of-sight sensor 12 is provided at such a position where the area of both eyes of the user is imaged, when the user operates the information processing terminal 10.

The touch panel 14 receives an input operation which is an example of a motion of a user. The touch panel 14 is superimposed on a display unit (not illustrated), for example, and receives an input operation such as tap, flick, swipe, pinch, and scroll by the user.

The microphone 16 acquires speech by utterance which is an example of the motion of the user. For example, as illustrated in FIG. 2, the microphone 16 is installed at a position where sound emitted from the user is acquired.

The information processing terminal 10 is controlled by a control unit (not illustrated). For example, the control unit controls the information processing terminal 10 so as to perform predetermined information processes, based on the input operation received on the touch panel 14 and the sound acquired by the microphone 16.

The calibration unit 18 includes a parameter storage unit 20, a line-of-sight detection unit 22, a motion detection unit 24, a motion storage unit 26, a motion determination unit 28, a data storage unit 30, and a processing unit 32. The line-of-sight sensor 12 and the line-of-sight detection unit 22 can be cited as an example of the line-of-sight sensor of the disclosed technology. Referring to FIG. 2, the dashed lines represent the line of sight of the user, and the position on the information processing terminal 10 that the line of sight intersects is referred to as the gaze position.

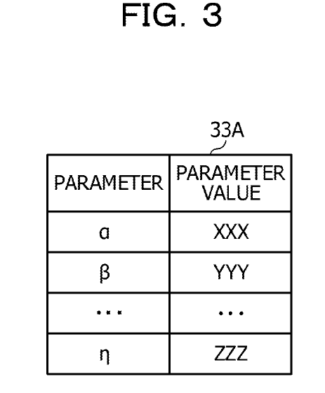

Parameters for detecting the line of sight or gaze position of the user are stored in the parameter storage unit 20. The parameters for detecting the line of sight of the user are stored, for example, in the form of a table as illustrated in FIG. 3. In the parameter table 33A illustrated in FIG. 3, parameters α, β, . . . , η are stored in association with parameter values, as an example of parameters for detecting the line of sight of the user.

The line-of-sight detection unit 22 detects the gaze position of the user, based on the line-of-sight information detected by the line-of-sight sensor 12 and the parameters stored in the parameter storage unit 20. Here, the gaze position of the user represents, for example, the plane coordinates on the touch panel 14, as illustrated in FIG. 2.

The motion detection unit 24 detects the motion of the user including the operation information and the sound information of the user. Specifically, as an example of the operation information of the user, the motion detection unit 24 detects the type of the input operation received on the touch panel 14 and the operation position of the input operation. For example, the motion detection unit 24 detects whether the type of the input operation is tap, flick, swipe, pinch, or scroll. Further, the motion detection unit 24 detects the operation position of the input operation on the touch panel 14. If the type of the input operation and the operation position of the input operation are detected, for example, a touch operation of an icon representing a specific product, a touch operation of a “cancel” icon representing a cancel operation, a touch operation of a “confirm” icon representing a final confirmation operation, or the like is detected. In addition, the motion detection unit 24 acquires the sound of the user acquired by the microphone 16, as an example of the sound information of the user.

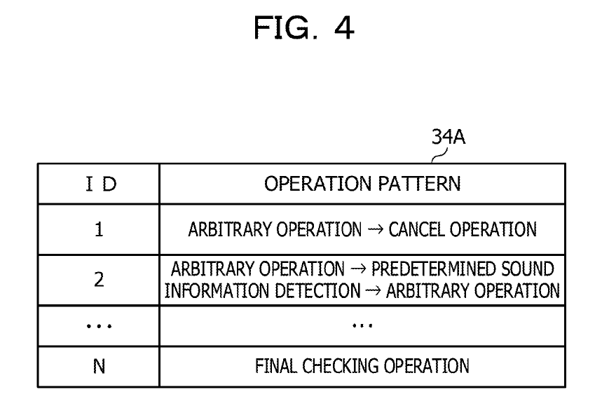

A plurality of operation patterns each indicating a predetermined motion are stored in the motion storage unit 26. The operation pattern is used when the calibration data is set by the motion determination unit 28 to be described later. The plurality of operation patterns are stored in the form of a table as illustrated in FIG. 4. In the operation pattern table 34A illustrated in FIG. 4, an ID representing the identification information of the operation pattern and an operation pattern are stored in association with each other. The motion storage unit 26 is an example of a storage unit of the disclosed technology.

Here, in a case where the user carefully performs an operation, there is a high possibility that the icon to be operated on the touch panel matches the line of sight of the user. Therefore, calibration can be performed with high accuracy by using the data of the gaze position and the operation position obtained when the user carefully performs an operation for calibration. Therefore, in the present embodiment, in order to determine an operation considered to be performed carefully by the user, as an example of an operation pattern indicating a predetermined motion, an operation pattern indicating a series of motions including an operation considered to be performed carefully by the user is stored in the motion storage unit 26. The operation pattern is an example of a motion which is predetermined in order to specify an operation carefully performed by the user in the disclosed technology.

For example, as illustrated in FIG. 4, “arbitrary operation→cancel operation” can be stored as an example of the operation pattern. “→” indicates the sequence of operations, and “arbitrary operation→cancel operation” indicates a series of motions in which a cancel operation is performed after an arbitrary operation is performed. The cancel operation is detected, for example, by detecting a touch operation on the “cancel” icon displayed on the touch panel 14.

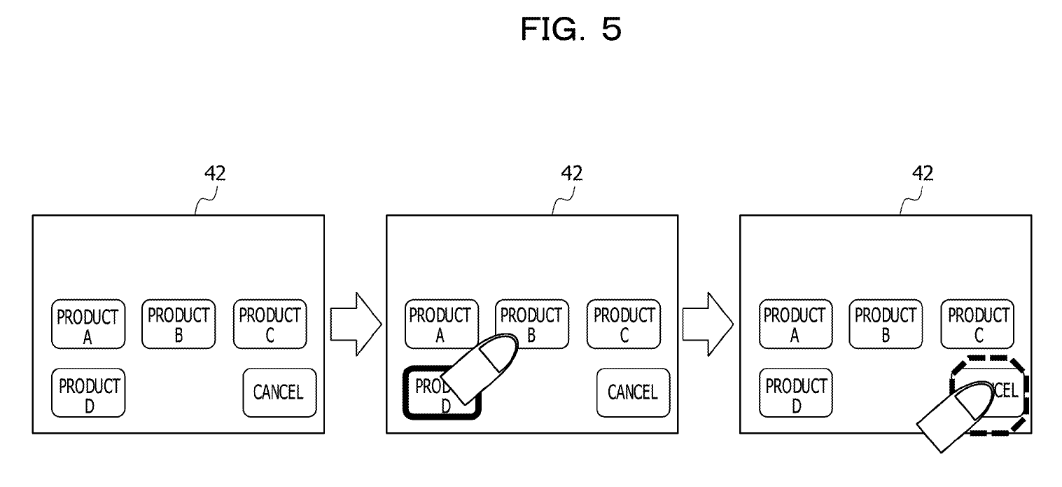

For example, as illustrated in FIG. 5, a case where the screen 40 is displayed on the touch panel will be described as an example. The screen 40 is a screen before the input operation by the user is performed. In this case, on the screen 40 on the touch panel, the user tries to touch the icon of “product B” with the fingertip. However, as illustrated on the screen 41, in a case where a part other than the fingertip touches the icon of “product D”, for example, the icon of “product D” is touched, the user touches the “cancel” icon, as illustrated on the screen 42. In this case, it is assumed that the user carefully performs the subsequent operations in order to undo the erroneous operation that the user does not intend. That is, in this operation pattern, the operation of touching the “cancel” icon is an operation considered to be performed carefully by the user.

On the screen 41, it is considered that the line of sight of the user is located on the icon of “product B”, but the operation position of the touch operation is located in “product D”. As described above, if calibration is performed using data obtained in a case where the gaze position and the operation position do not match each other, calibration may not be performed with high accuracy.

Therefore, in the present embodiment, for example, as illustrated in the screen 42 of FIG. 5, the gaze position and the operation position at the time when the “cancel” touch operation, which is considered to be performed carefully by the user, is used for calibration.

“Arbitrary operation→predetermined sound information detection→arbitrary operation” illustrated in the operation pattern table 34A is an example of an operation pattern indicating a series of motions in which after an arbitrary operation is performed, sound such as “ah” is issued, and thereafter an arbitrary operation is performed. In this operation pattern, “arbitrary operation” after “predetermined sound information detection” is an operation considered to be performed carefully by the user. With respect to “predetermined sound information detection”, information for determining whether it corresponds to a predetermined sound, for example, a feature amount of predetermined sound information and the like are also determined. In addition, the “final confirmation operation” illustrated in the operation pattern table 34A indicates that the “confirm” icon is touched after an arbitrary input operation is performed, for example. In this operation pattern, “final confirmation operation” is an operation considered to be performed carefully by the user.

On the other hand, for example, each of the following operations (1) to (4) is considered as an operation which is not carefully performed by the user.

(1) Touch operation at a location where there is no operation icon

(2) Touch operation performed before cancel operation

(3) Touch operation of the operation icon hidden by a hand different from the hand performing the touch operation (hereinafter, referred to as a hidden operation icon)

(4) Touch operation having a different predetermined operation procedure

(1) A touch operation at a location where there is no operation icon has a low possibility that the line of sight of the user is located at the corresponding position. Further, there is a possibility that the (2) a touch operation performed before the cancel operation has been operated without the user looking at the icon carefully.

Further, (3) the touch operation of the hidden operation icon has a high possibility that it is an operation not intended by the user. Further, (4) the touch operation different from a predetermined operation procedure has a high possibility that it is an erroneous operation, and has a possibility that an operation not intended by the user is included. In the case of such an operation, since it is considered that the operation position and the gaze position are separated from each other at the time of operation, the motions including these operations are not defined as the operation pattern stored in the motion storage unit 26.

The motion determination unit 28 determines whether or not the motion of the user detected by the motion detection unit 24 matches or is similar to any one of the operation patterns stored in the operation pattern table 34A of the motion storage unit 26. With respect to the determination as to whether or not the motion of the user matches or is similar to the operation pattern, for example, a similarity between the motion of the user and the operation pattern is calculated, and the determination can be performed according to the similarity and the preset threshold.

An example of a method of determining whether or not the motion of the user detected by the motion detection unit 24 matches or is similar to the operation pattern “arbitrary operation→predetermined sound information detection→arbitrary operation” will be described in detail. For example, the motion determination unit 28 acquires the type of the input operation included in the motion of the user detected by the motion detection unit 24 and sound information detection in time series, and specifies the operation pattern corresponding to the arrangement of the type of the input operation and the presence or absence of the detection of the sound information from the operation pattern table 34A. For example, in a case where the motion of the user detected by the motion detection unit 24 is a touch operation→sound information detection→touch operation, the motion determination unit 28 specifies, as an operation pattern corresponding to this motion, “an arbitrary operation→sound information detection→arbitrary operation”. The motion determination unit 28 calculates the similarity between the feature amount extracted from the detected sound information and the feature amount of the predetermined sound information included in the specified operation pattern. In a case where the degree of similarity is equal to or greater than the preset threshold, the motion determination unit 28 determines that the detected motion of the user is similar to the operation pattern “an arbitrary operation→a predetermined sound information detection→arbitrary operation”.

In addition, as a method of determining whether or not the motion of the user detected by the motion detection unit 24 matches or is similar to the operation pattern “an arbitrary operation→a cancel operation”, it is determined as match in a case where the types of operations match. Further, for example, in a case where “arbitrary operation” of the operation patterns is determined in advance, the degree of similarity between the “arbitrary operation” and the operation included in the motion of the users is calculated, and in a case where the degree of similarity is larger than the predetermined threshold, it is determined to be similar.

Similarly, as a method of determining whether or not the motion of the user detected by the motion detection unit 24 match or is similar to the operation pattern “final confirmation operation”, it is determined as match in a case where the types of operations match. Further, for example, in a case of performing a plurality of operations of which the operation sequence is previously determined, the similarity between the “final confirmation operation” and the operation by the user is calculated such that the closer the operation sequence to the “final confirmation operation”, the higher the similarity. In a case where the similarity is higher than a predetermined threshold, it is determined that they are similar.

Then, in a case where the motion of the user matches or is similar to the operation pattern in the operation pattern table 34A, the motion determination unit 28 acquires the operation position with respect to the information processing terminal 10 of the user, with respect to the “an operation considered to be performed carefully by the user” included in the operation pattern. For example, in the case of the operation pattern “arbitrary operation→predetermined sound information detection→arbitrary operation”, the operation position of “arbitrary operation” after “predetermined sound information detection” is acquired. In addition, the motion determination unit 28 acquires the gaze position of the user detected by the line-of-sight detection unit 22 using the line-of-sight information detected by the line-of-sight sensor 12 when the motion detection unit 24 detects the acquired operation position. Then, the motion determination unit 28 stores the combination of the acquired operation position and gaze position in the data storage unit 30 as calibration data

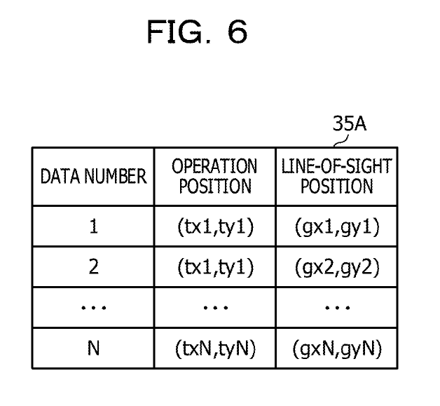

The calibration data representing the combination of the operation position and the gaze position, which are acquired by the motion determination unit 28, is stored in the data storage unit 30. The calibration data is stored in the form of a table as illustrated in FIG. 6, for example. In the calibration table 35A illustrated in FIG. 6, the data number indicating the identification information of the calibration data, the operation position, and the gaze position are stored in association with each other. Further, the operation position is represented by, for example, plane coordinates such as (tx1, ty2). tx1 represents the x coordinate on the touch panel, and ty2 represents the y coordinate on the touch panel. Further, the gaze position is represented by, for example, plane coordinates such as (gx1, gy2). gx1 represents the x coordinate on the touch panel, and gy2 represents the y coordinate on the touch panel.

The processing unit 32 calibrates the position of the line of sight detected from the line-of-sight detection unit 22, based on the calibration data stored in the data storage unit 30. Specifically, the processing unit 32 performs calibration, by adjusting the parameters stored in the parameter storage unit 20 such that the gaze position and the operation position match each other, based on the calibration data stored in the data storage unit 30.

Each of the parameters in the parameter storage unit 20, which is subjected to the calibration process by the processing unit 32, is used when the gaze position of the user is detected by the line-of-sight detection unit 22.

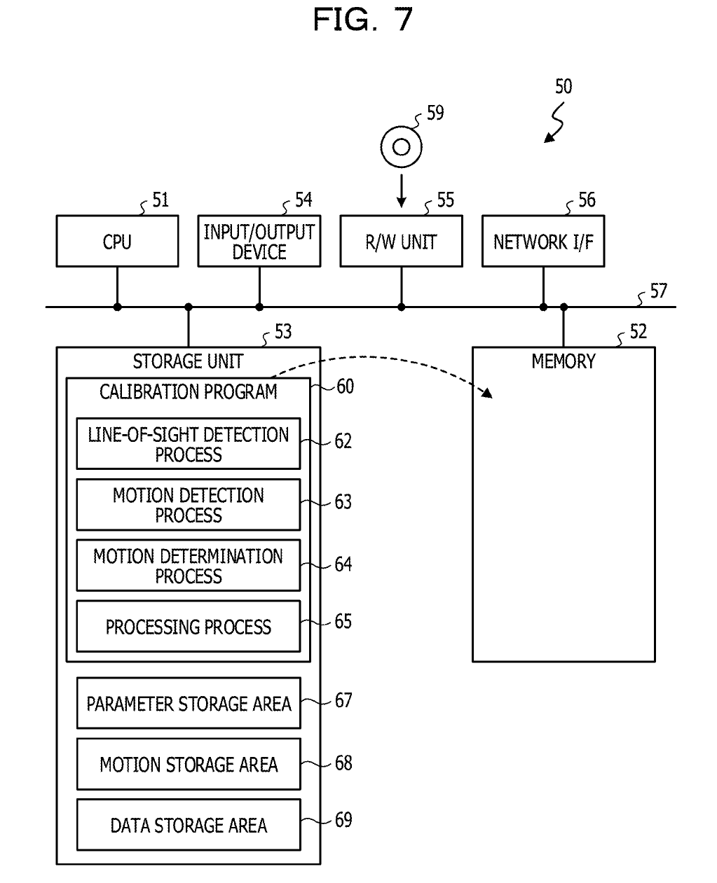

The calibration unit 18 of the information processing terminal 10 can be realized by the computer 50 illustrated in FIG. 7, for example. The computer 50 includes a CPU 51, a memory 52 which is a temporary storage area, and a nonvolatile storage unit 53. Further, the computer 50 includes a read/write (R/W) unit 55 that controls reading and writing of data with respect to an input/output device 54 such as a display device and an input device, and a recording medium 59. Further, the computer 50 includes a network interface (I/F) 56 connected to a network such as the Internet. The CPU 51, the memory 52, the storage unit 53, the input/output device 54, the R/W unit 55, and the network I/F 56 are connected to each other through a bus 57.

The storage unit 53 can be realized by a hard disk drive (HDD), a solid state drive (SSD), a flash memory, or the like. In the storage unit 53 which is a storage medium, a calibration program 60 for causing the computer 50 to function as the calibration unit 18 of the information processing terminal 10 is stored. The calibration program 60 includes a line-of-sight detection process 62, a motion detection process 63, a motion determination process 64, and a processing process 65. Further, the storage unit 53 includes a parameter storage area 67 in which information constituting the parameter storage unit 20 is stored, a motion storage area 68 in which information constituting the motion storage unit 26 is stored, and a data storage area 69 in which information constituting the data storage unit 30 is stored.

The CPU 51 reads the calibration program 60 from the storage unit 53, develops the calibration program 60 in the memory 52, and sequentially executes processes included in the calibration program 60. The CPU 51 operates as the line-of-sight detection unit 22 illustrated in FIG. 1, by executing the line-of-sight detection process 62. Further, the CPU 51 operates as the motion detection unit 24 illustrated in FIG. 1, by executing the motion detection process 63. Further, the CPU 51 operates as the motion determination unit 28 illustrated in FIG. 1, by executing the motion determination process 64. In addition, the CPU 51 operates as the processing unit 32 illustrated in FIG. 1, by executing the processing process 65. Further, the CPU 51 reads information from the parameter storage area 67, and develops the parameter storage unit 20 in the memory 52. Further, the CPU 51 reads information from the motion storage area 68, and develops the motion storage unit 26 in the memory 52. Further, the CPU 51 reads information from the data storage area 69, and develops the data storage unit 30 in the memory 52. Thus, the computer 50 that has executed the calibration program 60 functions as the calibration unit 18 of the information processing terminal 10. Therefore, the processor that executes the software calibration program 60 is hardware.

In addition, the function realized by the calibration program 60 can also be realized by, for example, a semiconductor integrated circuit, more specifically an application specific integrated circuit (ASIC) or the like.

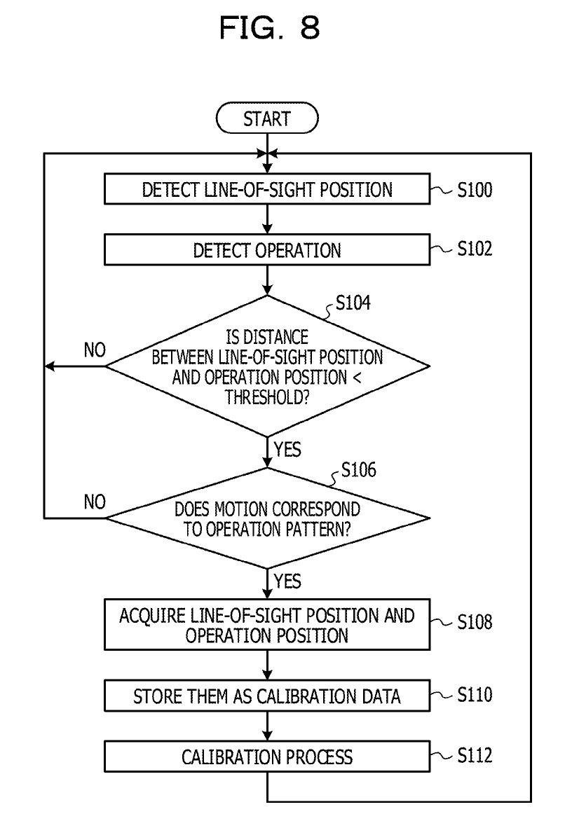

Next, the operation of the information processing terminal 10 according to the first embodiment will be described. In the information processing terminal 10, when the line-of-sight information of the user is acquired by the line-of-sight sensor 12, the input operation is acquired by the touch panel 14, and the sound of the user is acquired by the microphone 16, the calibration process illustrated in FIG. 8 is executed. Each process will be described in detail below.

In step S100, the line-of-sight detection unit 22 detects the gaze position of the user, based on the line-of-sight information detected by the line-of-sight sensor 12 and the parameters stored in the parameter storage unit 20.

In step S102, the motion detection unit 24 detects the type of the input operation and the operation position of the input operation received on the touch panel 14, and the sound acquired by the microphone 16, as the motion of the user.

In step S104, the motion determination unit 28 determines whether or not the distance between the gaze position detected in step S100 and the operation position detected in step S102 is smaller than a predetermined threshold. If the distance between the gaze position and the operation position is smaller than the predetermined threshold, the process proceeds to step S106. On the other hand, if the distance between the gaze position and the operation position is equal to or larger than the predetermined threshold, the process returns to step S100.

In step S106, the motion determination unit 28 determines whether or not the motion of the user detected in step S102 matches or is similar to any one of the operation patterns stored in the operation pattern table 34A of the motion storage unit 26. Then, in a case where it is determined that the detected motion of the user matches or is similar to any one of the operation patterns stored in the operation pattern table 34A of the motion storage unit 26, the motion determination unit 28 proceeds to step S108. On the other hand, in a case where it is determined that the detected motion of the user does not match or is dissimilar to any one of the operation patterns stored in the operation pattern table 34A of the motion storage unit 26, the motion determination unit 28 returns Step S100.

In step S108, the motion determination unit 28 acquires the gaze position detected in step S100 and the operation position of the input operation detected in step S102.

In step S110, the motion determination unit 28 stores the gaze position and the operation position, acquired in step S108, in the data storage unit 30, as calibration data.

In step S112, the processing unit 32 performs calibration by adjusting the parameters stored in the parameter storage unit 20 such that the gaze position and the operation position match each other, based on the calibration data stored in the data storage unit 30.

As described above, the information processing terminal 10 according to the first embodiment detects the motion of the user, and determines whether or not the detected motion matches or is similar to the operation pattern stored in advance in the motion storage unit 26. Then, in a case where the detected motion matches or is similar to the operation pattern, the information processing terminal 10 detects the operation position of the user with respect to the information processing terminal 10 and detects the gaze position of the user obtained from the line-of-sight sensor 12. The information processing terminal 10 calibrates the position of the line of sight to be detected by the line-of-sight detection unit 22, based on the operation position and the gaze position, which are detected. This makes it possible to perform the calibration for the detection process of the line of sight of the user with high accuracy.

Further, by determining whether or not the user has carefully performed the operation, it is possible to associate the operation position with the gaze position only in a case where the user carefully performs the operation. Therefore, the accuracy of the calibration can be improved.

### Second Embodiment

Next, a second embodiment of the disclosed technology will be described. The same parts as those in the first embodiment are denoted by the same reference numerals, and description thereof will be omitted.

In the second embodiment, a case where a user wears a glass type or a head mounted display (HMD) type information processing terminal will be described as an example. The second embodiment is different from the first embodiment in that calibration is performed using the line of sight of the user in a case where the user is working in a real space or a virtual space.

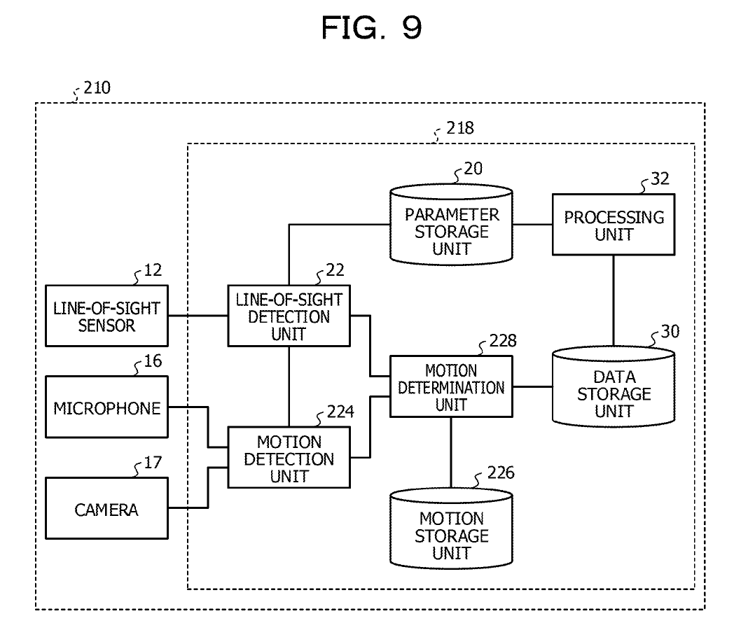

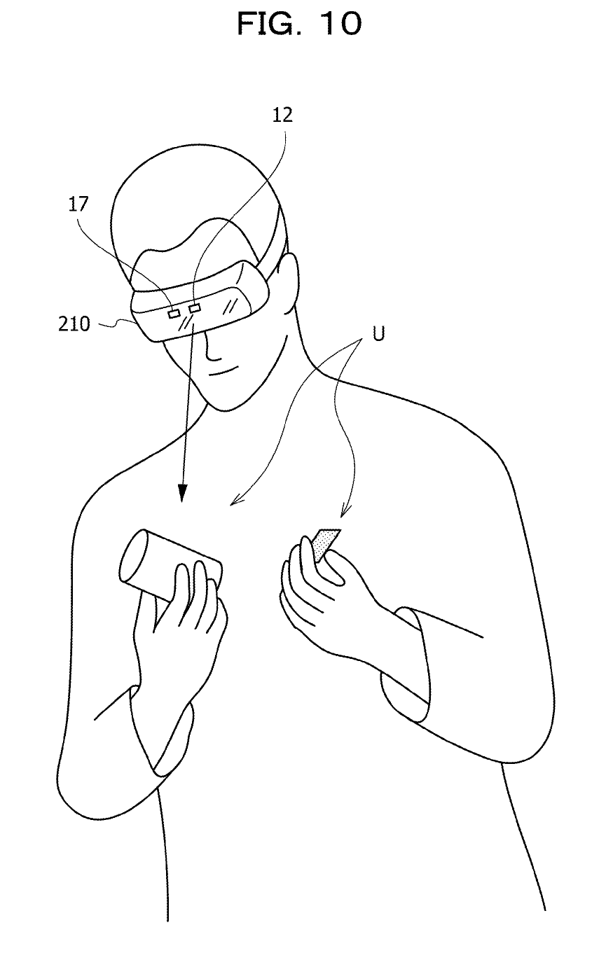

The information processing terminal 210 according to the second embodiment illustrated in FIG. 9 includes a line-of-sight sensor 12, a microphone 16, a camera 17, and a calibration section 218. In the second embodiment, a case where the information processing terminal 210 is realized by the HMD as illustrated in FIG. 10 will be described as an example.

The camera 17 images an area in the forward direction of the user. For example, as illustrated in FIG. 10, the camera 17 is installed on the front surface of the HMD which is the information processing terminal 210. Therefore, when the user performs some operations on the operation target U, the operation target U is imaged by the camera 17.

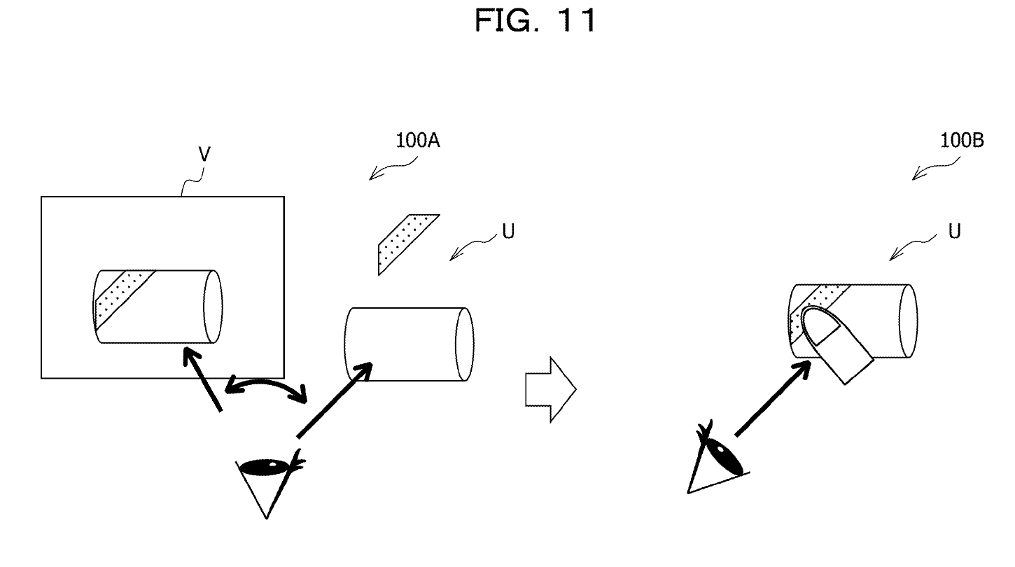

Further, in the present embodiment, as illustrated in FIG. 11, a case where a manual V regarding the operation is displayed on the left side as viewed from the user and the outside of the HMD is displayed on the right side on the display unit (not illustrated) of the HMD which is the information processing terminal 210 will be described as an example. As illustrated in FIG. 11, the user operates the operation target U, while referring to the manual V displayed on the left side of the HMD.

The motion detection unit 224 detects the motion of the user based on the captured image captured by the camera 17. For example, the motion detection unit 224 inputs a captured image to a previously generated target model, and senses whether or not an operation target is included in the captured image. Further, the motion detection unit 224 inputs a captured image to a motion model generated in advance, and recognizes what type of motion is being performed by the user. In addition, the motion detection unit 224 acquires the movement of the gaze position of the user detected by the line-of-sight detection unit 22 as the motion of the user. Then, the motion detection unit 224 acquires the sound of the user acquired by the microphone 16 as the motion of the user. That is, the motion detection unit 224 detects the motion of the users, including the operation type and operation position of the input operation, the gaze position of the user, and the sound which is an example of sound information issued by the user, which is an example of the operation information of the user.

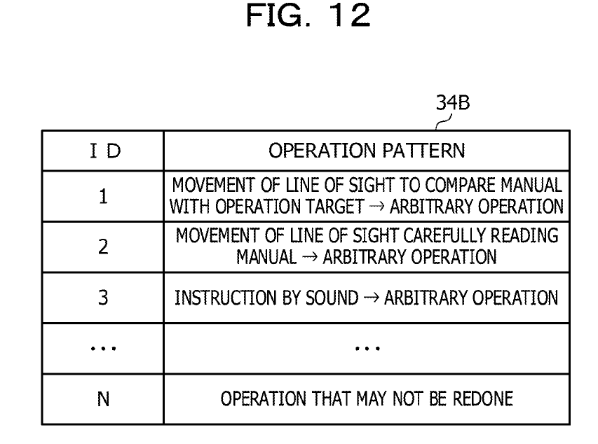

A plurality of operation patterns which are an example of predetermined motions are stored in the motion storage unit 226. The plurality of operation patterns in the second embodiment are stored in the form of a table as illustrated in FIG. 12, for example. In the operation pattern table 34B illustrated in FIG. 12, an ID representing the identification information of the operation pattern and the operation pattern are stored in association with each other. The motion storage unit 226 is an example of a storage unit of the disclosed technology.

For example, as illustrated in FIG. 12, “movement of line of sight to compare a manual with an operation target→arbitrary operation” is stored as an example of the operation pattern. Since “movement of line of sight to compare a manual with an operation target→arbitrary operation” can be considered as the motion performed by the user when a careful operation is performed on the operation target, it is stored as an operation pattern. Specifically, a case where an arbitrary operation is sensed after a motion in which the line of sight of the user travels between the manual and the operation target is repeated a predetermined number of times or more is stored as an operation pattern.

Further, similarly, since the operation “movement of the line of sight to carefully read the manual→the arbitrary operation” illustrated in the operation pattern table 34B is considered as a motion performed by the user in a case where the operation target is operated carefully, and then the operation is stored as an operation pattern. Specifically, the case where the line of sight of the user is located in the vicinity of the manual and an arbitrary operation is sensed after it is detected that the movement speed of the line of sight of the user is the predetermined speed or less is stored as the operation pattern.

With respect to “instruction by sound”→“arbitrary operation” illustrated in the operation pattern table 34B, for example, a motion of performing an operation after reading out a manual or the like is considered to be a motion carefully performed by the user, and therefore it is stored as an operation pattern. Specifically, a case where an arbitrary operation is sensed after detecting a predetermined sound (for example, a sound for reading out a part of the manual) is stored as an operation pattern.

Further, since “operation that may not be redone” is considered as a motion performed carefully by the user, it is stored as an operation pattern. “Operation that may not be redone” is set in advance, and it is determined by the motion determination unit 228 described later whether or not it is a motion corresponding to “operation that may not be redone”.

For example, as illustrated in FIG. 11, the gaze position and the operation position are used as calibration data, when the user performs an operation of comparing the manual and the operation target in a scene 100A and then performs an operation on the operation target in a scene 100B.

On the other hand, for example, each of the following operations (5) to (7) is considered as an operation which is not carefully performed by the user.

(5) A case where the manual is not checked

(6) A case where the operation result is different from the content of the manual

(7) A case where the operation speed is too fast

In (5) a case where the manual is not checked, there is a high possibility that the operation by the user is not performed carefully. Further, (6) the case where the operation result is different from the content of the manual has a possibility that the user performs operation without viewing the manual or the operation target well. In (7) a case where the operation speed is too fast, there is a high possibility that the operation of the user is not performed carefully. In the case of such an operation, since it is considered that the operation position and the gaze position are separated from each other at the time of operation, the motions including these operations are not defined as the operation pattern stored in the motion storage unit 26.

The motion determination unit 228 determines whether or not the motion of the user detected by the motion detection unit 224 matches or is similar to any one of the operation patterns stored in the operation pattern table 34B stored in the motion storage unit 226.

In a case where the detected motion of the user matches or is similar to the operation pattern, the motion determination unit 228 acquires the operation position of the user with respect to the operation target. In addition, the motion determination unit 228 acquires the gaze position of the user detected by the line-of-sight detection unit 22 using the line-of-sight information detected by the line-of-sight sensor 12 when the motion detection unit 224 detects the acquired operation position. Then, the motion determination unit 228 stores the combination of the acquired operation position and gaze position in the data storage unit 30 as calibration data.

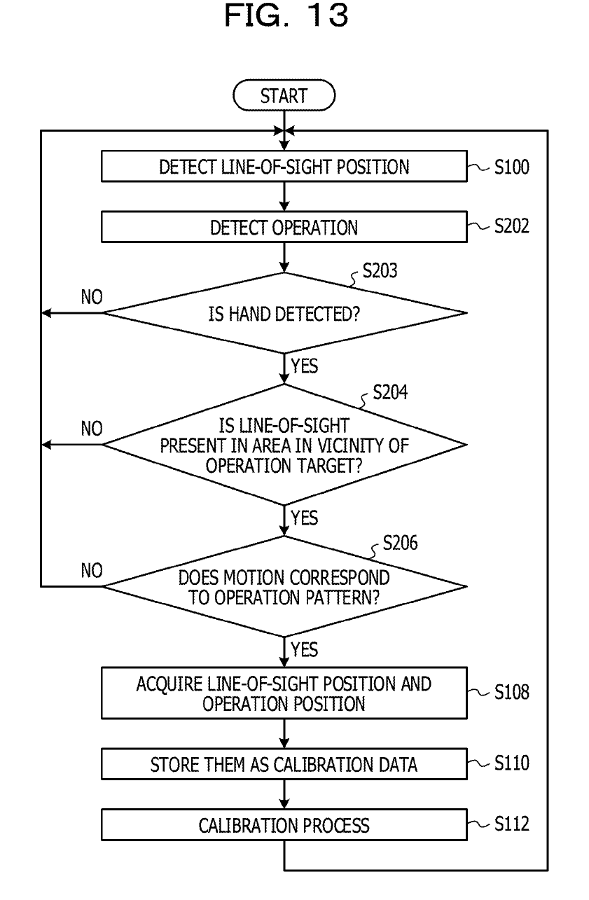

Next, the operation of the information processing terminal 210 according to the second embodiment will be described. When the user wears the information processing terminal 210, the line-of-sight information of the user is acquired by the line-of-sight sensor 12, the area in the front direction of the user is imaged by the camera 17, and the sound of the user is acquired by the microphone 16, the calibration process illustrated in FIG. 13 is executed. Each process will be described in detail below.

In step S202, the motion detection unit 224 detects the motion of the user, based on the captured image captured by the camera 17, the sound of the user acquired by the microphone 16, and the line of sight of the user detected in step S100.

In step S203, the motion detection unit 224 determines whether or not the hand of the user is detected from the captured image captured by the camera 17, in the detection result detected in step S202. In a case where the hand of the user is detected, the process proceeds to step S204. On the other hand, in a case where the hand of the user is not detected, the process returns to step S100.

In step S204, it is determined whether or not the line of sight of the user detected in step S100 is present in the area around the operation target. In a case where the line of sight of the user is present in the area around the operation target, the process proceeds to step S206. On the other hand, in a case where the line of sight of the user is not present in the area around the operation target, the process returns to step S100. In addition, the area around the operation target is set in advance, and it is determined whether or not the line of sight of the user is present in the area around the operation target, for example, by a predetermined image recognition process.

In step S206, the motion determination unit 228 determines whether or not the motion of the user detected in step S202 matches or is similar to any one of the operation patterns stored in the operation pattern table 34B of the motion storage unit 226. Then, in a case where it is determined that the detected user's motion matches or is similar to any one of the operation patterns stored in the operation pattern table 34B of the motion storage unit 226, the motion determination unit 228 proceeds to Step S108. On the other hand, in a case where it is determined that the detected motion of the user does not match or is dissimilar to any one of the operation patterns stored in the operation pattern table 34B of the motion storage unit 226, the motion determination unit 228 returns Step S100.

Steps S108 to S112 are executed in the same manner as in the first embodiment.

As described above, the information processing terminal 210 according to the second embodiment detects the motion of the user, and determines whether or not the detected motion matches or is similar to the operation pattern stored in advance in the motion storage unit 226. Then, in a case where the detected motion matches or is similar to the operation pattern, the information processing terminal 210 detects the operation position of the user with respect to the operation target and detects the gaze position of the user obtained from the line-of-sight sensor 12. Then, the information processing terminal 210 calibrates the position of the line of sight to be detected by the line-of-sight detection unit 22, based on the operation position and the gaze position, which are detected. Thus, in a case where the user performs an operation on the operation target, it is possible to perform the calibration for the detection process of the line of sight of the user with high accuracy.

### Third Embodiment

Next, a third embodiment of the disclosed technology will be described. The same parts as those in the first and second embodiments are denoted by the same reference numerals, and description thereof will be omitted.

The third embodiment is different from the first or second embodiment in that the calibration is performed using the line of sight of the user who is performing the checking work.

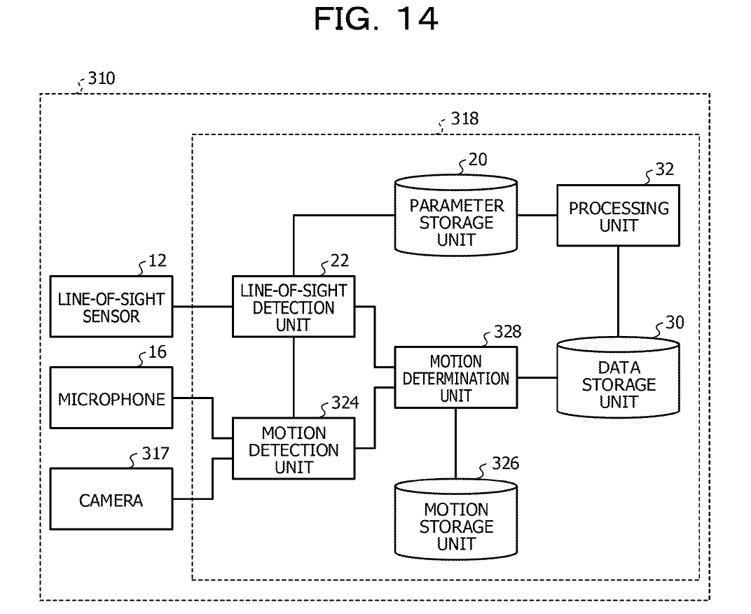

The calibration device 310 according to the third embodiment illustrated in FIG. 14 includes a line-of-sight sensor 12, a microphone 16, a camera 317, and a calibration section 318.

The camera 317 images the entire user. For example, the camera 317 is installed at a position where an area including the finger of the user who performs finger pointing checking or the like is imaged, for example, at a position where the entire image of the user is imaged.

The motion detection unit 324 inputs the captured image captured by the camera 317 to a motion model generated in advance, and detects what type of motion is performing by the user. In addition, the motion detection unit 324 acquires the movement of the gaze position of the user detected by the line-of-sight detection unit 22 as the motion of the user. In addition, the motion detection unit 324 acquires the sound of the user acquired by the microphone 16 as the motion of the user.

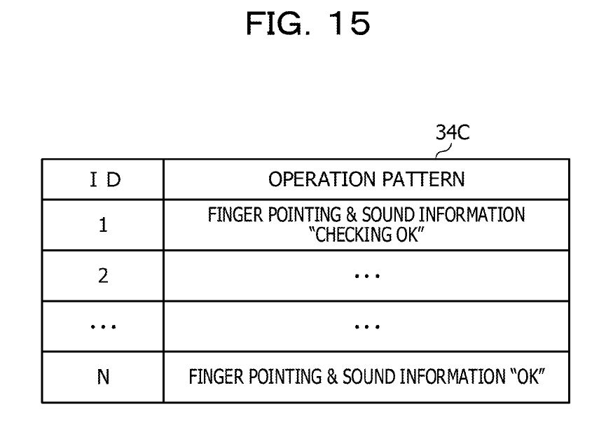

A plurality of operation patterns which are an example of predetermined motions are stored in the motion storage unit 326. The plurality of operation patterns in the third embodiment are stored in the form of a table as illustrated in FIG. 15, for example. In the operation pattern table 34C illustrated in FIG. 15, an ID representing the identification information of the operation pattern and the operation pattern are stored in association with each other. The motion storage unit 326 is an example of a storage unit of the disclosed technology.

For example, as illustrated in FIG. 15, “finger pointing→sound information “checking OK” is stored as an example of the operation pattern. “Finger pointing→sound information “checking OK” is considered to be a motion performed by the user in a case of performing the checking work and is considered to be a motion performed carefully by the user, so it is stored in the motion storage unit 326 as an operation pattern. Further, since “finger pointing→sound information “OK”” is considered to be a motion performed carefully by the user, so it is stored in the motion storage unit 326 as an operation pattern.

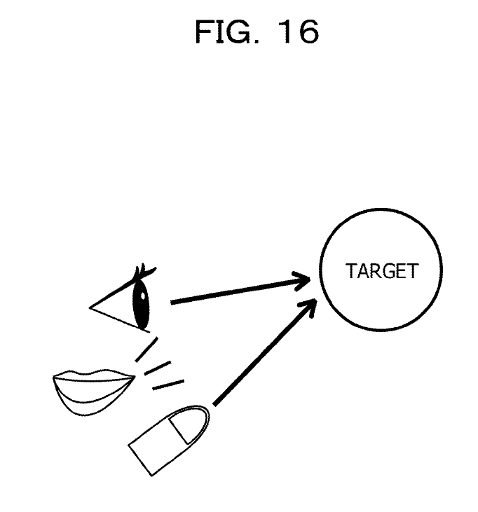

For example, as illustrated in FIG. 16, when a user performs finger pointing checking with respect to a target, it is considered that the indicated position indicating the direction indicated by the user's finger matches the gaze position of the user. Further, when a finger pointing checking is performed, it is considered that a sound for checking is issued by the user. Therefore, the gaze position and the indicated position at the time when the checking work by the user is performed are set as the calibration data.

The motion determination unit 328 determines whether or not the motion of the user detected by the motion detection unit 324 matches or is similar to any one of the operation patterns stored in the operation pattern table 34C stored in the motion storage unit 326. In a case where the detected motion of the user matches or is similar to any of the operation patterns, the motion determination unit 328 detects the position indicated by the user's finger. In addition, the motion determination unit 328 acquires the gaze position of the user detected by the line-of-sight detection unit 22 using the line-of-sight information detected by the line-of-sight sensor 12 when the motion detection unit 324 detects the finger pointing motion. Then, the motion determination unit 328 stores the combination of the acquired indicated position and gaze position in the data storage unit 30 as calibration data. The finger pointing motion is an example of the operation position with respect to the object.

The processing unit 32 according to the third embodiment performs calibration, by adjusting the parameters stored in the parameter storage unit 20 such that the gaze position and the indicated position match each other, based on the calibration data stored in the data storage unit 30.

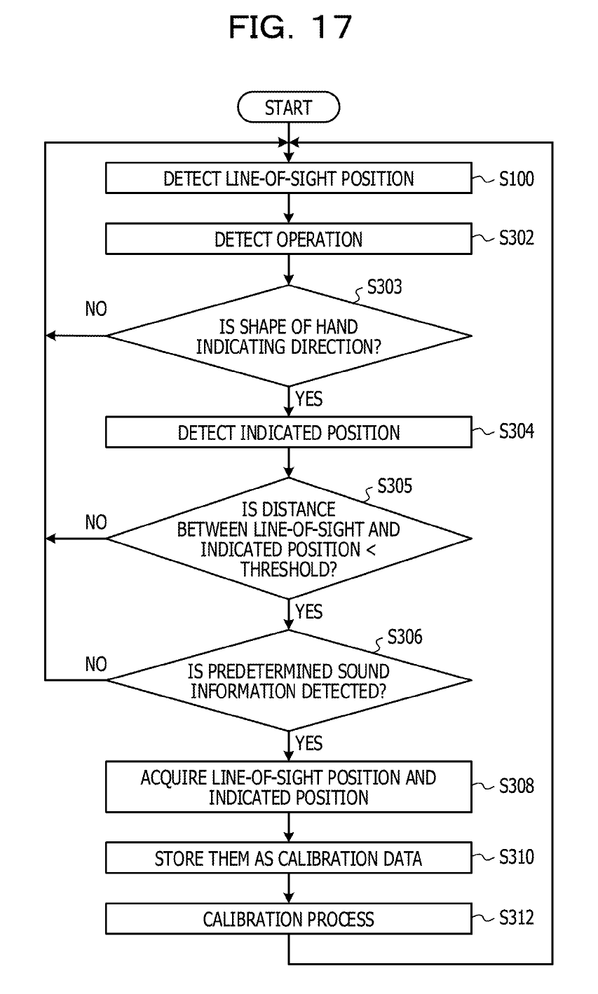

Next, the operation of the calibration device 310 according to the third embodiment will be described. When the line-of-sight information of the user is acquired by the line-of-sight sensor 12 of the calibration device 310, the area including the finger of the user is imaged by the camera 317, and the sound of the user is acquired by the microphone 16, the calibration process illustrated in FIG. 17 is executed. Each process will be described in detail below.

In step S302, the motion detection unit 324 detects the motion of the user, based on the captured image captured by the camera 317, the line of sight of the user detected in step S100, and the sound of the user acquired by the microphone 16.

In step S303, the motion detection unit 324 determines whether or not the hand of the user obtained from the captured image captured by the camera 17 has the shape of a hand instructing the direction, based on the detection result detected in step S302. In a case where the hand of the user has the shape of the hand indicating the direction, the process proceeds to step S304. On the other hand, in a case where the hand of the user does not have the shape of the hand instructing the direction, the process returns to step S100.

In step S304, the motion detection unit 324 detects the position indicated by the user's finger obtained from the captured image captured by the camera 17, based on the detection result obtained in step S302.

In step S305, the motion determination unit 328 determines whether or not the distance between the gaze position detected in step S100 and the indicated position detected in step S304 is smaller than a predetermined threshold. If the distance between the gaze position and the indicated position is smaller than the predetermined threshold, the process proceeds to step S306. On the other hand, if the distance between the gaze position and the indicated position is equal to or larger than the predetermined threshold, the process returns to step S100.

In step S306, the motion determination unit 328 determines whether or not the motion of the user detected in step S302 matches or is similar to any operation pattern in the operation pattern table 34C stored in the motion storage unit 326. Specifically, in step S306, the motion determination unit 328 determines whether or not the sound of the user acquired by the microphone 16 is predetermined sound information, based on the detection result obtained in step S302. When the sound of the user is predetermined sound information (for example, “checking OK” or “OK”), the process proceeds to step S308. On the other hand, in a case where the sound of the user is not the predetermined sound information, the process returns to step S100.

In step S308, the motion determination unit 328 acquires the gaze position detected in step S100 and the indicated position detected in step S304.

In step S310, the motion determination unit 328 stores the gaze position and the indicated position, acquired in step S308, in the data storage unit 30, as calibration data.

In step S312, the processing unit 32 performs calibration by adjusting the parameters stored in the parameter storage unit 20 such that the gaze position and the indicated position match each other, based on the calibration data stored in the data storage unit 30.

As described above, the calibration device 310 according to the third embodiment detects the motion of the user, and determines whether or not the detected motion matches or is similar to the operation pattern that is stored in advance in the motion storage unit 326. Then, in a case where the detected motion matches or similar to the operation pattern, the calibration device 310 detects the position indicated by the user with respect to the target, and detects the gaze position of the user obtained from the line-of-sight sensor 12. Then, the calibration device 310 calibrates the position of the line of sight to be detected by the line-of-sight detection unit 22, based on the detected operation position and the indicated position. Thus, in a case where the user performs the checking work, it is possible to perform the calibration for the detection process of the line of sight of the user with high accuracy.

### Fourth Embodiment

Next, a fourth embodiment of the disclosed technology will be described. The same parts as those in the first to third embodiments are denoted by the same reference numerals, and description thereof will be omitted.

The fourth embodiment is different from the first to third embodiments in that in a case where the operation sequence is determined in advance, when an erroneous operation is performed during the operation, the carefulness degree is changed and set before and after the erroneous operation is performed, and calibration is performed according to the carefulness degree.

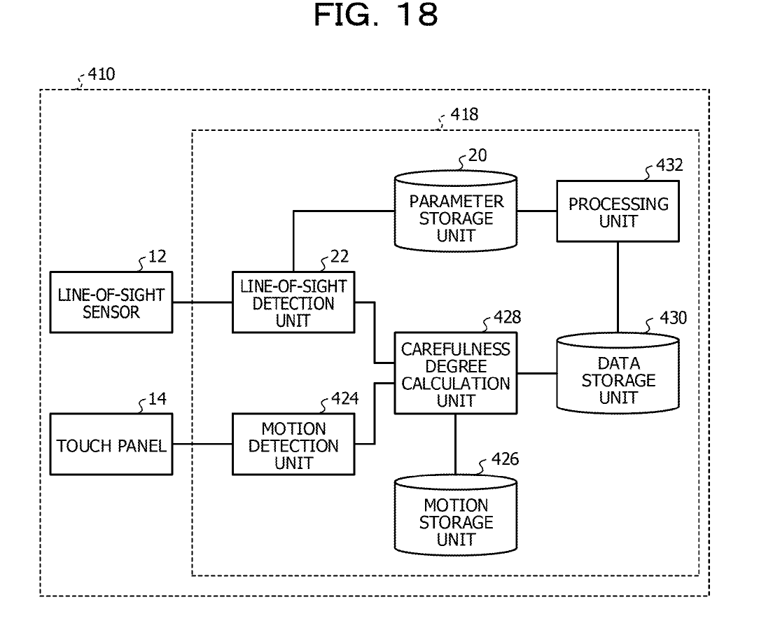

The information processing terminal 410 illustrated in FIG. 18 includes a line-of-sight sensor 12, a touch panel 14, and a calibration unit 418. The information processing terminal 410 receives an input operation from the user and performs an information process according to the input operation. The information processing terminal 410 is realized by, for example, a smartphone or the like.

As an example of the motion of the user, the motion detection unit 424 detects the type of the input operation received on the touch panel 14 and the operation position of the input operation. In the present embodiment, a case where the type of the input operation is only a touch operation will be described as an example.

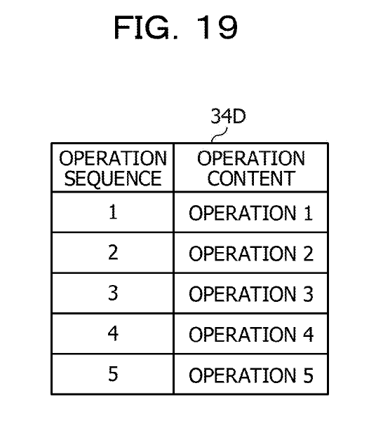

The operation sequence and the operation content are stored in association with each other as an operation pattern which is an example of a predetermined motion in the motion storage unit 426. The operation pattern is stored in the form of a table as illustrated in FIG. 19, for example. In the operation pattern table 34D illustrated in FIG. 19, the operation sequence and the operation content are stored in association with each other. The operation content is determined in advance, for example, such as “a touch operation of an icon A”, and “a touch operation of an icon B”. The motion storage unit 426 is an example of a storage unit of the disclosed technology.

The carefulness degree calculation unit 428 determines whether or not each operation content is performed according to the operation sequence in the operation pattern table 34D stored in the motion storage unit 426, with respect to each motion of the user detected by the motion detection unit 424. Then, the carefulness degree calculation unit 428 sets the carefulness degree according to the determination result.

For example, immediately after an error in the operation sequence, it is considered that the user carefully performs the operation, so there is a high possibility that the operation position for the operation immediately after the error in the operation sequence matches the gaze position of the user. Therefore, as a setting method of a carefulness degree representing the degree of carefulness of the operation of the user, the carefulness degree of an operation performed immediately after mistaking the operation sequence is set to be high, and the carefulness degrees of the subsequent operations are set to decrease gradually.

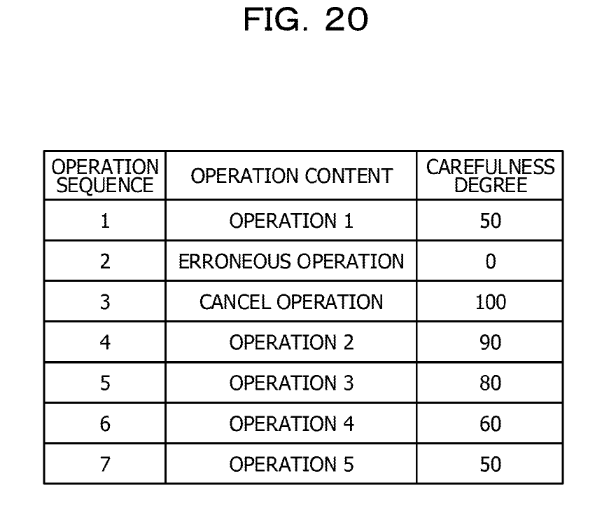

FIG. 20 illustrates an example of a setting method of a carefulness degree representing the degree of carefulness of the operation of the user. In the example of FIG. 20, the carefulness degree calculation unit 428 sets the carefulness degree to 50, in a case where an operation matching the operation sequence and the operation content in the operation pattern table 34D is performed. In addition, the carefulness degree calculation unit 428 sets the carefulness degree to 0, in a case where an operation (“an erroneous operation” illustrated in FIG. 20) different from the operation sequence and the operation content in the operation pattern table 34D is performed. Then, as illustrated in FIG. 20, the carefulness degree calculation unit 428 sets the carefulness degree for the operation immediately after “an erroneous operation” is performed (“cancel operation” illustrated in FIG. 20) to 100, and sets the carefulness degree to be reduced by 10 at once with respect to the subsequent operations of the cancel operation. In this example, the larger the value of the carefulness degree, the higher the carefulness degree, that is, the higher the possibility that the user performs an operation carefully.

Then, the carefulness degree calculation unit 428 stores the combination of the operation position of the user detected by the motion detection unit 424, the gaze position of the user detected by the line-of-sight detection unit 22, and the set the carefulness degree in the data storage unit 30, as calibration data.

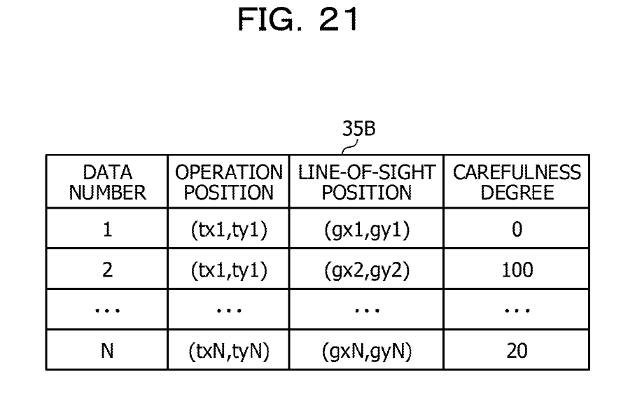

The calibration data representing the combination of the operation position, the gaze position, and the carefulness degree, which are acquired by the carefulness degree calculation unit 428, is stored in the data storage unit 430. The calibration data is stored in the form of a table as illustrated in FIG. 21, for example. In the calibration table 35B illustrated in FIG. 21, the data number indicating the identification information of the calibration data, the operation position, the gaze position, and the carefulness degree are stored in association with each other.

The processing unit 432 calibrates the position of the line of sight detected from the line-of-sight detection unit 22, based on the calibration data stored in the data storage unit 430. Specifically, the processing unit 432 selects calibration data corresponding to a predetermined condition, from the plurality of calibration data stored in the data storage unit 430.

For example, the processing unit 432 selects the top N calibration data with a high carefulness degree, from a plurality of calibration data. Alternatively, the processing unit 432 selects the top X % of calibration data with a high carefulness degree, from the plurality of calibration data. Alternatively, the processing unit 432 selects calibration data with a higher degree of carefulness than a predetermined threshold, from the plurality of calibration data

Then, the processing unit 432 performs calibration, by adjusting the parameters stored in the parameter storage unit 20 such that the gaze position and the operation position match each other, based on the selected calibration data. Alternatively, the processing unit 432 may perform calibration by weighting each of the selected calibration data according to the carefulness degree.

In addition, the calibration by the processing unit 432 may be performed at a specific timing or may be performed while the input operation of the user is performed.

Further, when selecting the calibration data, a number of different operation positions may be selected. Further, the calibration data may be selected, based on the reliability with respect to time (for example, setting the reliability higher for the calibration data acquired at the time closer to the current time).

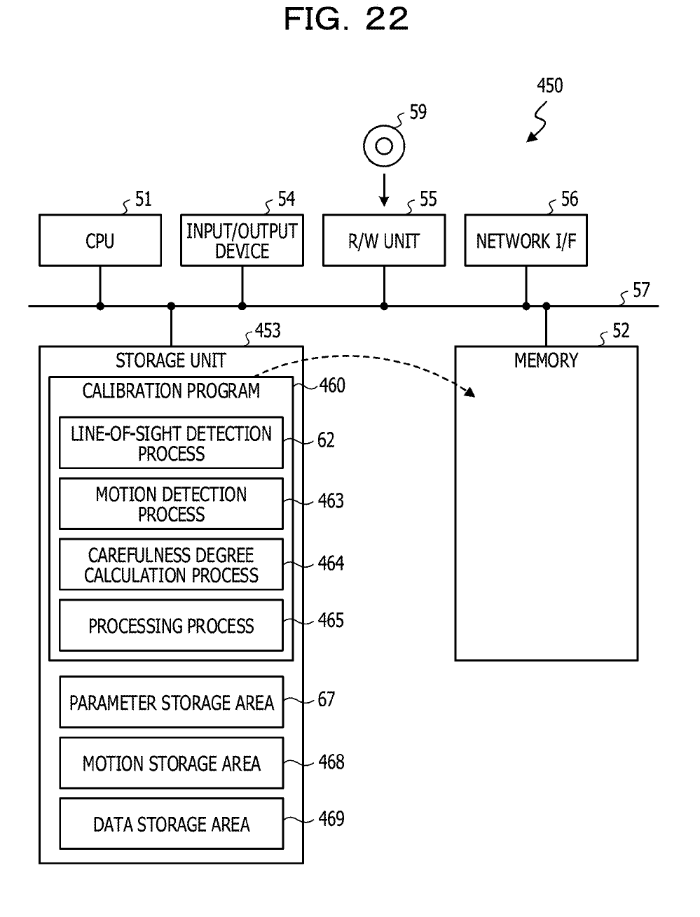

The calibration unit 418 of the information processing terminal 410 can be realized by the computer 450 illustrated in FIG. 22, for example. The computer 450 includes a CPU 51, a memory 52 which is a temporary storage area, and a nonvolatile storage unit 453. Further, the computer 450 includes a R/W unit 55 that controls reading and writing of data with respect to an input/output device 54 such as a display device and an input device, and a recording medium 59. Further, the computer 450 includes a network I/F 56 connected to a network such as the Internet. The CPU 51, the memory 52, the storage unit 453, the input/output device 54, the R/W unit 55, and the network I/F 56 are connected to each other through a bus 57.

The storage unit 453 can be realized by a HDD, an SSD, a flash memory, or the like. In the storage unit 453 which is a storage medium, a calibration program 460 for causing the computer 450 to function as the calibration unit 418 of the information processing terminal 410 is stored. The calibration program 460 includes a line-of-sight detection process 62, a motion detection process 463, a carefulness degree calculation process 464, and a processing process 465. Further, the storage unit 453 includes a parameter storage area 67 in which information constituting the parameter storage unit 20 is stored, a motion storage area 468 in which information constituting the motion storage unit 426 is stored, and a data storage area 469 in which information constituting the data storage unit 430 is stored.

The CPU 51 reads the calibration program 460 from the storage unit 453, develops the calibration program 460 in the memory 52, and sequentially executes processes included in the calibration program 460. The CPU 51 operates as the line-of-sight detection unit 22 illustrated in FIG. 18, by executing the line-of-sight detection process 62. Further, the CPU 51 operates as the motion detection unit 424 illustrated in FIG. 18, by executing the motion detection process 463. In addition, the CPU 51 operates as the carefulness degree calculation unit 428 illustrated in FIG. 18 by executing the carefulness degree calculation process 464. In addition, the CPU 51 operates as the processing unit 432 illustrated in FIG. 18, by executing the processing process 465. Further, the CPU 51 reads information from the parameter storage area 67, and develops the parameter storage unit 20 in the memory 52. Further, the CPU 51 reads information from the motion storage area 468, and develops the motion storage unit 426 in the memory 52. Further, the CPU 51 reads information from the data storage area 469, and develops the data storage unit 430 in the memory 52. Thus, the computer 450 that has executed the calibration program 460 functions as the calibration unit 418 of the information processing terminal 410. Therefore, the processor that executes the software calibration program 460 is hardware.

In addition, the function realized by the calibration program 460 can also be realized by, for example, a semiconductor integrated circuit, more specifically an ASIC or the like.

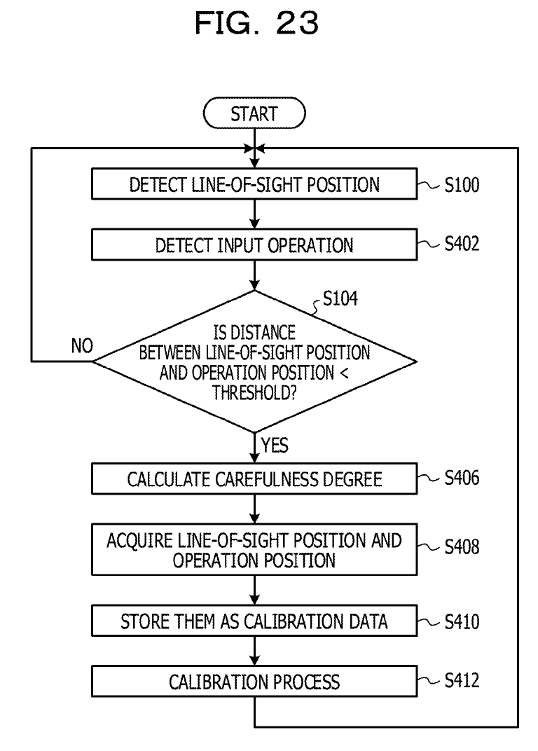

Next, the operation of the information processing terminal 410 according to the fourth embodiment will be described. In the information processing terminal 410, when the line-of-sight information of the user is acquired by the line-of-sight sensor 12, and the input operation is acquired by the touch panel 14, the calibration process illustrated in FIG. 23 is executed. Each process will be described in detail below.

In step S402, the motion detection unit 424 detects the input operation received on the touch panel 14 and the operation position of the input operation, as the motion of the user.

In step S406, the carefulness degree calculation unit 428 determines whether or not each operation content is performed according to the operation sequence in the operation pattern table 34D stored in the motion storage unit 426, with respect to each motion of the user detected in step S402. Then, the carefulness degree calculation unit 428 sets the degree of carefulness according to the determination result.

In step S408, the carefulness degree calculation unit 428 acquires the gaze position detected in step S100 and the operation position detected in step S402.

In step S410, the carefulness degree calculation unit 428 stores, in the data storage unit 430, a combination of the gaze position and the operation position, which are acquired in step S408, and the carefulness degree set in the step S406, as calibration data.

In step S412, the processing unit 432 selects the calibration data of which the carefulness degree satisfies the predetermined condition, from the calibration data stored in the data storage unit 430. Then, the processing unit 432 performs calibration, by adjusting the parameters stored in the parameter storage unit 20 such that the gaze position and the indicated position match each other, based on the selected calibration data.

As described above, the information processing terminal 410 according to the fourth embodiment calculates the carefulness degree representing the degree of carefulness of the detected motion of the user, based on the detected user's motion and the operation pattern. Then, the information processing terminal 410 acquires the operation position of the user with respect to the information processing terminal 410 according to the carefulness degree, and acquires the gaze position of the user using the line of sight sensor 12. This makes it possible to accurately calibrate the detection process of the line of sight of the user, according to the carefulness degree of the operation set based on the erroneous operation by the user.

### Fifth Embodiment

Next, a fifth embodiment of the disclosed technology will be described. The same parts as those in the first to fourth embodiments are denoted by the same reference numerals, and description thereof will be omitted.

The fifth embodiment is different from the first to fourth embodiments in that the calibration data obtained for each user is used to calibrate the parameters of the line-of-sight sensor of the information processing terminal operated by the user.

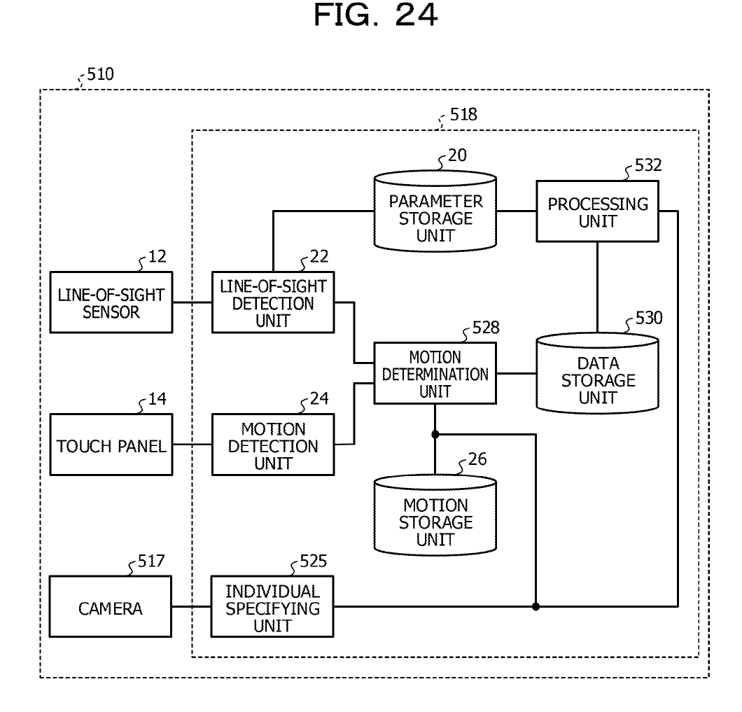

The information processing terminal 510 illustrated in FIG. 24 includes a line-of-sight sensor 12, a touch panel 14, a camera 517, and a calibration unit 518.

The camera 517 images the face area of the user. The image of the face area of the user (hereinafter, also referred to as “face image”) is used by an individual specifying unit 525 to be described later when the user is specified.

The individual specifying unit 525 specifies the user, based on the image of the face area of the user imaged by the camera 517 and, for example, a user identification model which is generated in advance. The user identification model is a model that can specify a user from a face image. Further, the individual specifying unit 525 outputs a time section in which the same user is specified.

In a case where the detected motion of the user matches or is similar to the operation pattern, the motion determination unit 528 obtains the operation position of the user, and acquires the gaze position of the user detected by the line-of-sight detection unit 22, by using the line-of-sight sensor 12. Further, the motion determination unit 528 acquires the user ID corresponding to the user specified by the individual specifying unit 525. Then, the motion determination unit 528 stores the combination of the acquired operation position, the gaze position, and the user ID, in the data storage unit 530 as calibration data.

The calibration data representing the combination of the operation position, the gaze position, and the user ID, which are acquired by the motion determination unit 528, is stored in the data storage unit 530. In the data storage unit 530, calibration data generated for each user is stored. The data storage unit 530 is an example of a storage unit of the disclosed technology.

The processing unit 532 acquires the calibration data corresponding to the user specified by the individual specifying unit 525. Then, in the time section output by the individual specifying unit 525, the processing unit 32 performs calibration, by adjusting the parameters stored in the parameter storage unit 20 such that the gaze position and the operation position match each other, based on the acquired calibration data.

In a case where the user ID corresponding to the user specified by the individual specifying unit 525 is not stored in the data storage unit 530, the processing unit 532 acquires the calibration data corresponding to another user. Then, the processing unit 32 performs calibration, by adjusting the parameters stored in the parameter storage unit 20 such that the gaze position and the operation position match each other, based on the acquired calibration data.

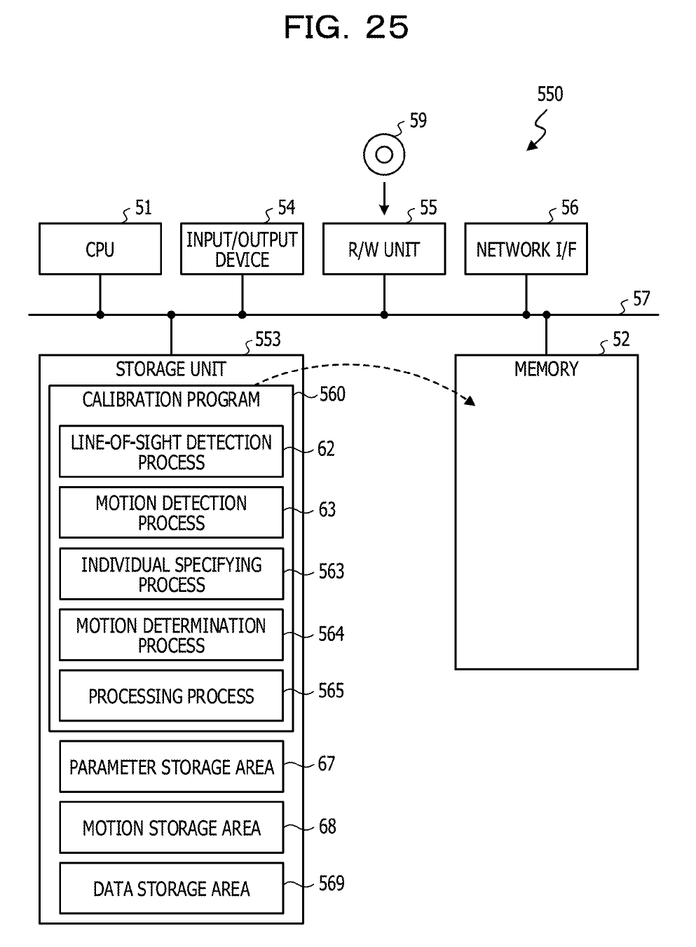

The calibration unit 518 of the information processing terminal 510 can be realized by the computer 550 illustrated in FIG. 25, for example. The computer 550 includes a CPU 51, a memory 52 which is a temporary storage area, and a nonvolatile storage unit 553. Further, the computer 550 includes a R/W unit 55 that controls reading and writing of data with respect to an input/output device 54 such as a display device and an input device, and a recording medium 59. Further, the computer 550 includes a network I/F 56 connected to a network such as the Internet. The CPU 51, the memory 52, the storage unit 553, the input/output device 54, the R/W unit 55, and the network I/F 56 are connected to each other through a bus 57.

The storage unit 553 can be realized by a HDD, an SSD, a flash memory, or the like. In the storage unit 553 which is a storage medium, a calibration program 560 for causing the computer 550 to function as the calibration unit 518 of the information processing terminal 510 is stored. The calibration program 560 includes a line-of-sight detection process 62, a motion detection process 63, an individual specifying process 563, a motion determination process 564, and a processing process 565. Further, the storage unit 553 includes a parameter storage area 67 in which information constituting the parameter storage unit 20 is stored, a motion storage area 68 in which information constituting the motion storage unit 526 is stored, and a data storage area 569 in which information constituting the data storage unit 530 is stored.

The CPU 51 reads the calibration program 560 from the storage unit 553, develops the calibration program 560 in the memory 52, and sequentially executes processes included in the calibration program 560. The CPU 51 operates as the line-of-sight detection unit 22 illustrated in FIG. 24, by executing the line-of-sight detection process 62. Further, by executing the motion detection process 63, the CPU 51 operates as the motion detection unit 24 illustrated in FIG. 24. Further, the CPU 51 operates as the individual specifying unit 525 illustrated in FIG. 24, by executing the individual specifying process 563. Further, the CPU 51 operates as the motion determination unit 528 illustrated in FIG. 24, by executing the motion determination process 564. In addition, the CPU 51 operates as the processing unit 532 illustrated in FIG. 24, by executing the processing process 565. Further, the CPU 51 reads information from the parameter storage area 67, and develops the parameter storage unit 20 in the memory 52. Further, the CPU 51 reads information from the motion storage area 68, and develops the motion storage unit 26 in the memory 52. Further, the CPU 51 reads information from the data storage area 569, and develops the data storage unit 530 in the memory 52. Thus, the computer 50 that has executed the calibration program 560 functions as the calibration unit 518 of the information processing terminal 510. Therefore, the processor that executes the software calibration program 560 is hardware.

In addition, the function realized by the calibration program 560 can also be realized by, for example, a semiconductor integrated circuit, more specifically an ASIC or the like.

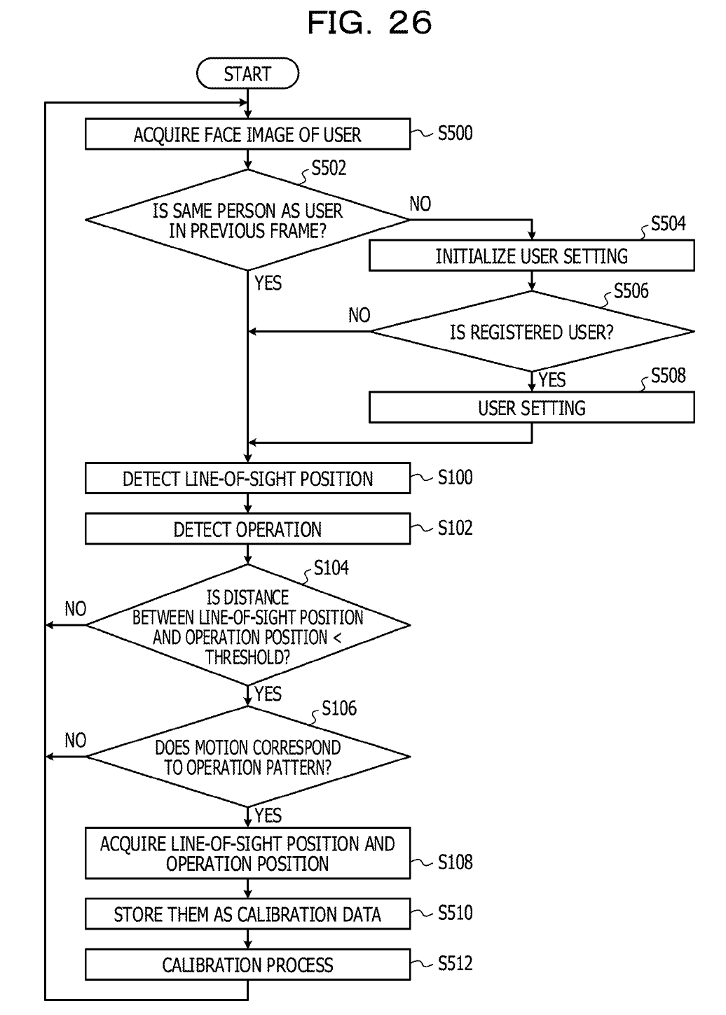

Next, the operation of the information processing terminal 510 according to the fifth embodiment will be described. In the information processing terminal 510, when the line-of-sight information of the user is acquired by the line-of-sight sensor 12, the input operation is acquired by the touch panel 14, and the face area of the user is imaged by the camera 517, the calibration process illustrated in FIG. 26 is executed. Each process will be described in detail below.

In step S500, the individual specifying unit 525 acquires an image of the face area of the user captured by the camera 517.

In step S502, the individual specifying unit 525 specifies the user based on the face image of the user acquired in step S500 and the user identification model. Then, the individual specifying unit 525 determines whether or not the specified based on the face image of the user of the previous frame. In a case where the specified user is the same person as the user specified from the face image of the user of the previous frame, the process proceeds to step S100. On the other hand, in a case where the specified user is not the same person as the user specified from the face image of the user of the previous frame, the process proceeds to step S504.

In step S504, the individual specifying unit 525 initializes the user setting which is set in step S508 in the previous cycle.

In step S506, the individual specifying unit 525 determines whether or not the user specified in step S502 is a user registered in the data storage unit 530. In a case where the specified user is a registered user, the process proceeds to step S508. On the other hand, if the specified user is not a user registered in the data storage unit 530, the process proceeds to step S100.

In step S508, the user ID corresponding to the user specified in step S502 is set as the user ID used for the calibration.

Steps S100 to S108 are executed in the same manner as in the first embodiment.

In step S510, the motion determination unit 328 stores the combination of the operation position acquired in step S102, the gaze position acquired in step S100, and the user ID set in step S508, as calibration data, in the data storage unit 530.

In step S512, the processing unit 532 acquires the calibration data corresponding to the user ID set in step S508. Then, the processing unit 32 performs calibration, by adjusting the parameters stored in the parameter storage unit 20 such that the gaze position and the operation position match each other, based on the acquired calibration data.

As described above, the information processing terminal 510 according to the fifth embodiment acquires the calibration data corresponding to the specified user, from each of the calibration data generated for each user. Then, the information processing terminal 510 calibrates the position of the line of sight to be detected by the line-of-sight detection unit 22, based on the acquired calibration data. This makes it possible to perform the calibration for each user with high accuracy.

In addition, calibration according to the characteristics of the user can be performed with high accuracy.

### Sixth Embodiment

Next, a sixth embodiment of the disclosed technology will be described. The same parts as those in the first to fifth embodiments are denoted by the same reference numerals, and description thereof will be omitted.

The sixth embodiment is different from the first to fifth embodiments in that a calibration method is selected according to the number of calibration data pieces.

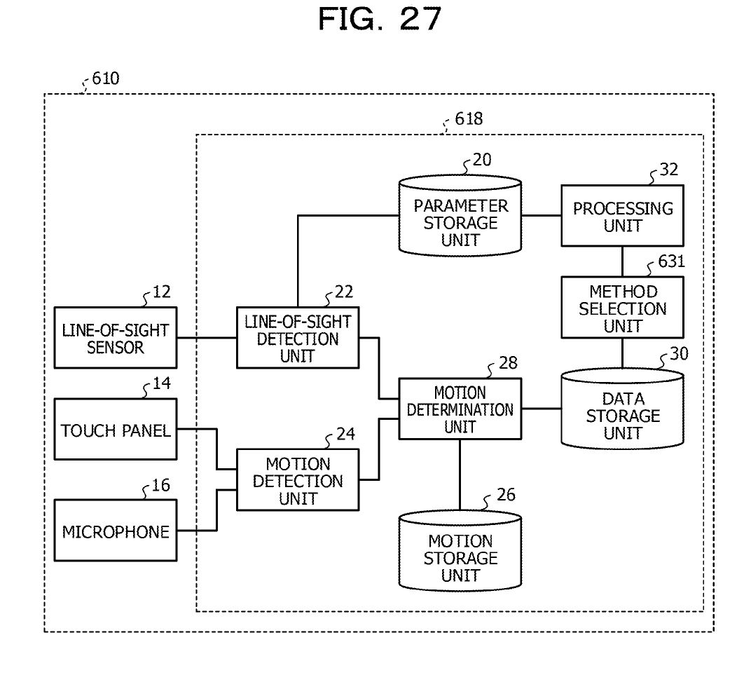

The information processing terminal 610 illustrated in FIG. 27 includes a line-of-sight sensor 12, a touch panel 14, a microphone 16, and a calibration unit 618.

The method selection unit 631 selects a calibration method for performing the calibration, according to the number of the calibration data pieces stored in the data storage unit 30.

Depending on the number of calibration data pieces, equations that can be solved are different. Therefore, when calibration is performed, as the number of calibration data pieces increases, a more complicated equation can be adopted as an equation for performing calibration. Therefore, in the present embodiment, a calibration method for performing calibration is selected according to the number of calibration data pieces available for calibration.

For example, in a case where the number of calibration data pieces stored in the data storage unit 30 is 1 to 3, the method selection unit 631 selects a calibration method by parallel movement. Further, in a case where the number of calibration data pieces stored in the data storage unit 30 is four or more, the method selection unit 631 selects a calibration method by projective transformation.

The processing unit 32 of the sixth embodiment performs the calibration by adjusting the parameters stored in the parameter storage unit 20 by using the calibration method selected by the method selection unit 631.

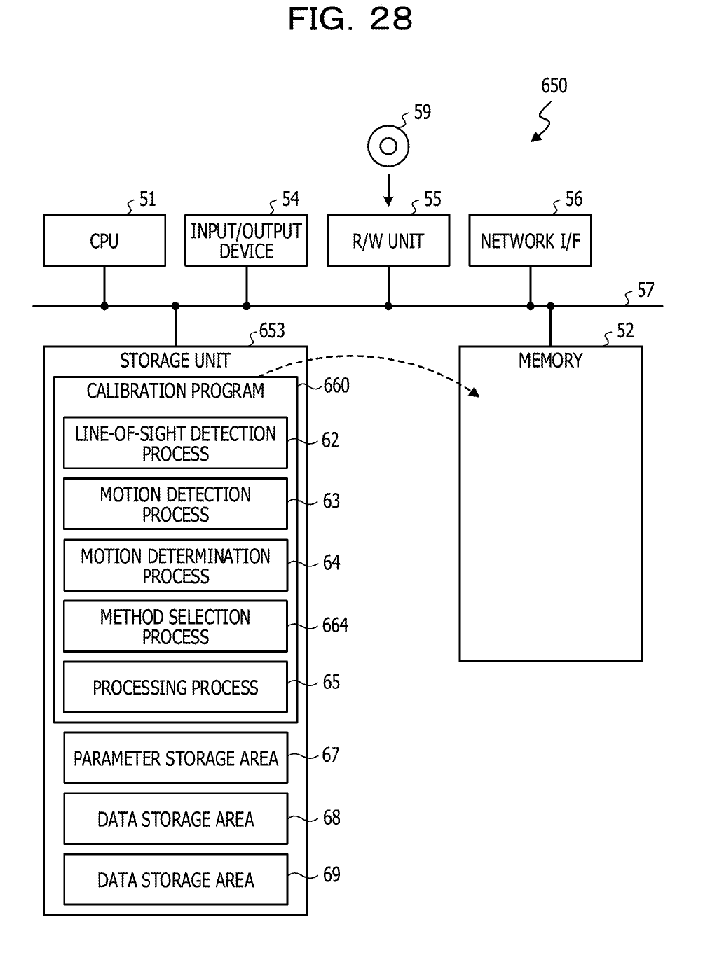

The calibration unit 618 of the information processing terminal 610 can be realized by the computer 650 illustrated in FIG. 28, for example. The computer 650 includes a CPU 51, a memory 52 which is a temporary storage area, and a nonvolatile storage unit 653. Further, the computer 650 includes a R/W unit 55 that controls reading and writing of data with respect to an input/output device 54 such as a display device and an input device, and a recording medium 59. Further, the computer 650 includes a network I/F 56 connected to a network such as the Internet. The CPU 51, the memory 52, the storage unit 653, the input/output device 54, the R/W unit 55, and the network I/F 56 are connected to each other through a bus 57.

The storage unit 653 can be realized by a HDD, an SSD, a flash memory, or the like. In the storage unit 653 which is a storage medium, a calibration program 660 for causing the computer 650 to function as the calibration unit 618 of the information processing terminal 610 is stored. The calibration program 660 includes a line-of-sight detection process 62, a motion detection process 63, a motion determination process 64, a method selection process 664, and a processing process 65. Further, the storage unit 653 includes a parameter storage area 67 in which information constituting the parameter storage unit 20 is stored, a motion storage area 68 in which information constituting the motion storage unit 26 is stored, and a data storage area 69 in which information constituting the data storage unit 30 is stored.

The CPU 51 reads the calibration program 660 from the storage unit 653, develops the calibration program 660 in the memory 52, and sequentially executes processes included in the calibration program 660. The CPU 51 operates as the line-of-sight detection unit 22 illustrated in FIG. 27, by executing the line-of-sight detection process 62. Further, by executing the motion detection process 63, the CPU 51 operates as the motion detection unit 24 illustrated in FIG. 27. Further, the CPU 51 operates as the motion determination unit 28 illustrated in FIG. 27, by executing the motion determination process 64. Further, the CPU 51 operates as the method selection unit 631 illustrated in FIG. 27, by executing the method selection process 664. Further, the CPU 51 operates as the processing unit 32 illustrated in FIG. 27 by executing the processing process 65. Further, the CPU 51 reads information from the parameter storage area 67, and develops the parameter storage unit 20 in the memory 52. Further, the CPU 51 reads information from the motion storage area 68, and develops the motion storage unit 26 in the memory 52. Further, the CPU 51 reads information from the data storage area 69, and develops the data storage unit 30 in the memory 52. Thus, the computer 650 that has executed the calibration program 660 functions as the calibration unit 618 of the information processing terminal 610. Therefore, the processor that executes the software calibration program 660 is hardware.

In addition, the function realized by the calibration program 660 can also be realized by, for example, a semiconductor integrated circuit, more specifically an ASIC or the like.

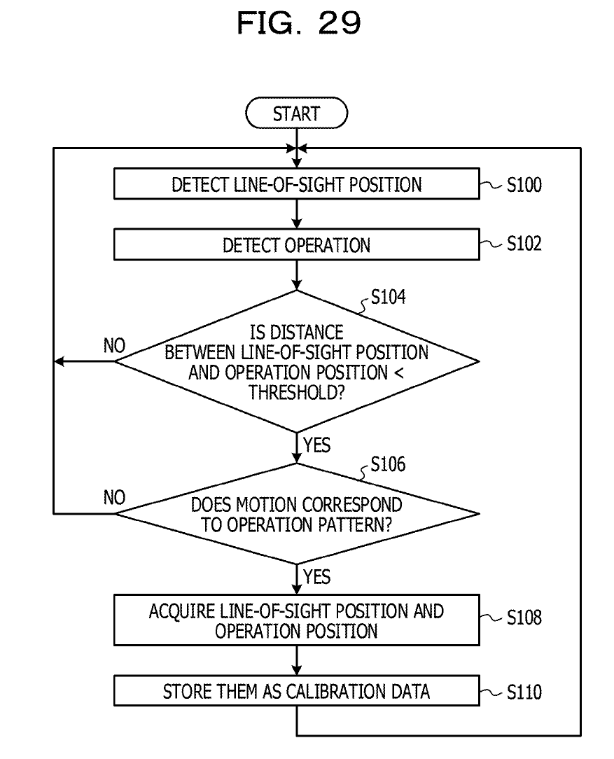

Next, the operation of the information processing terminal 610 according to the sixth embodiment will be described. In the sixth embodiment, a case where the calibration data acquisition process and the calibration process are separately performed will be described as an example. In the information processing terminal 610, when the line-of-sight information of the user is acquired by the line-of-sight sensor 12, the input operation is acquired by the touch panel 14, and the sound of the user is acquired by the microphone 16, the calibration data acquisition process illustrated in FIG. 29 is executed.

Steps S100 to S110 of the calibration acquisition process are executed in the same manner as the steps S100 to S110 of the calibration process (FIG. 8) in the first embodiment.

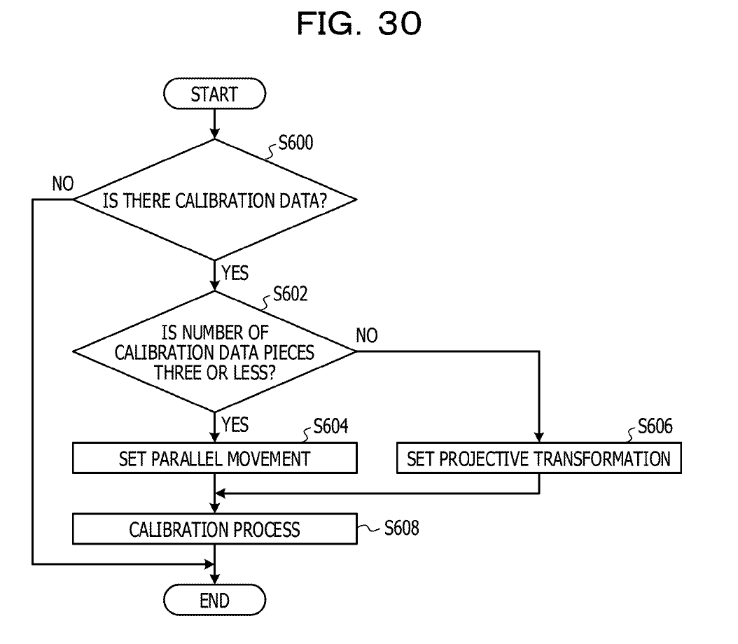

Next, the calibration process will be described. When the calibration data is acquired by the calibration data acquisition process illustrated in FIG. 29, the calibration process illustrated in FIG. 30 is executed.

In step S600, the method selection unit 631 determines whether or not there is calibration data in the data storage unit 30. In a case where there is the calibration data in the data storage unit 30, the process proceeds to step S602. On the other hand, in a case where there is no calibration data in the data storage unit 30, the calibration process is terminated.

In step S602, the method selection unit 631 determines whether or not the number of calibration data pieces stored in the data storage unit 30 is three or less. In a case where the number of calibration data pieces stored in the data storage unit 30 is three or less, the process proceeds to step S604. On the other hand, in a case where the number of calibration data pieces stored in the data storage unit 30 is larger than three, the process proceeds to step S606.

In step S604, the method selection unit 631 selects a calibration method by parallel movement.

In step S606, the method selection unit 631 selects a calibration method by projective transformation.

In step S608, the processing unit 32 performs calibration by adjusting the parameters stored in the parameter storage unit 20, using the calibration method selected in step S604 or S606.

As described above, the information processing terminal 610 according to the sixth embodiment selects a calibration method for performing the calibration according to the number of the calibration data pieces. Then, the information processing terminal 610 calibrates the position of the line of sight to be detected by the line-of-sight detection unit 22, based on the operation position and gaze position, by using the selected calibration method. Thus, calibration according to the number of calibration data pieces can be accurately performed.

In the above description, an aspect in which the calibration program is stored (installed) in advance in the storage unit has been described, but the present disclosure is not limited thereto. The program according to the disclosed technique can also be provided in a form recorded on a recording medium such as a CD-ROM, a DVD-ROM, a USB memory, or the like.

All literature, patent applications and technical standards described in this specification are incorporated herein by reference to the same extent as in a case where individual literature, patent applications, and technical standards are incorporated by reference specifically and individually.

Next, a modification example of each embodiment will be described.

In each of the above embodiments, the case where the calibration process is performed in the information processing terminal operated by the user has been described as an example, but the present disclosure is not limited thereto. For example, the calibration unit of each of the above-described embodiments may be provided in a server that is an external device of the information processing terminal, and the server may perform the calibration process, by the information processing terminal communicating with the server. Then, the information processing terminal acquires the parameter calibrated by the server, and detects the gaze position of the user.

In each of the above-described embodiments, the case where the operation pattern is used as an example of the predetermined motion has been described as an example. However, the present disclosure is not limited to this, and any motion may be performed as long as it is a predetermined user's motion.

In the first embodiment, the case where the operation patterns illustrated in FIG. 4 are stored as an example of a predetermined motion in the motion storage unit 26, and the motion determination unit 28 determines whether the motion of the user matches or is similar to the operation patterns is described as an example, the present disclosure is not limited to this case. For example, the above operation patterns (1) to (3) are stored in the motion storage unit 26, and the motion determination unit 28 determines whether the motion of the user is dissimilar to the operation patterns. In a case where the motion of the user is dissimilar to the operation pattern, the motion determination unit 28 may acquire the operation position and the gaze position, and store the combination of the acquired operation position and gaze position in the data storage unit 30 as calibration data.

In this case, for example, the motion determination unit 28 determines whether or not the motion of the user detected by the motion detection unit 24 is dissimilar to (1) a touch operation at a position where there is no operation icon. Further, the motion determination unit 28 determines whether or not the motion of the user detected by the motion detection unit 24 is dissimilar to (2) the touch operation performed before the cancel operation. Further, the motion determination unit 28 determines whether or not the motion of the user detected by the motion detection unit 24 is dissimilar to (3) the touch operation of the hidden operation icon.

the motion of the user can be determined, for example, by a method described below, as a method of determining whether or not the motion of the user is dissimilar to (3) the touch operation of the hidden operation icon.

For example, the motion detection unit 24 senses which one of the right hand and the left hand is a hand different from the hand performing the touch operation (the hand holding the information processing terminal 10). For example, in a case where a sensor (not illustrated) that detects the inclination of the information processing terminal 10 itself is provided in the information processing terminal 10, the motion detection unit 24 senses which one of the right hand and the left hand is the hand holding the information processing terminal 10, according to the inclination obtained by the sensor. Further, it is assumed that the area that would be hidden by the hand holding the information processing terminal 10 is set in advance.

Then, in a case where a touch operation is detected within an area hidden by the hand holding the information processing terminal 10, the motion determination unit 28 determines that it is a touch operation of the hidden operation icon. On the other hand, in a case where a touch operation is not detected within an area hidden by the hand holding the information processing terminal 10, the motion determination unit 28 determines that it is dissimilar to the touch operation of the hidden operation icon.

Further, for example, the motion detection unit 24 may sense which one of the right hand and the left hand is the hand performing the touch operation, according to the pressure distribution on the touch panel 14. Then, the motion detection unit 24 can sense a hand different from the hand performing the touch operation as the hand holding the information processing terminal 10. In addition, for example, in a case where a hand operating the information processing terminal 10 can be selected, such as a right-hand mode or a left-hand mode, the motion detection unit 24 can sense a hand different from the hand in the selected mode, as the hand having the information processing terminal 10.

the motion of the user can be determined, for example, by a method described below, as a method of determining whether or not the motion of the user is (4) a touch operation which is dissimilar to a predetermined operation procedure.

For example, predetermined operation procedures are stored in a storage unit or the like in the information processing terminal 10, and the motion detection unit 24 senses the sequence of the touch operation. Then, the motion determination unit 28 compares the sequence of the touch operation sensed by the motion detection unit 24 with the operation procedure stored in the storage unit or the like, and determines whether or not the sequence of the sensed operation is dissimilar to the operation procedure.

Further, in the second embodiment, as an example of a predetermined motion, the case where the operation patterns illustrated in FIG. 12 are stored in the motion storage unit 226, and the motion determination unit 228 determines whether or not the motion of the user matches or is similar to the operation patterns is described as an example, but the present disclosure is not limited to this case. For example, the above operation patterns (5) to (7) are stored in the motion storage unit 226, and the motion determination unit 228 determines whether or not the motion of the user is dissimilar to the operation patterns. In a case where the motion of the user is dissimilar to the operation pattern, the motion determination unit 228 may acquire the operation position and the gaze position, and store the combination of the acquired operation position and gaze position in the data storage unit 230 as calibration data.

In this case, for example, the motion determination unit 228 determines whether or not the motion of the user detected by the motion detection unit 224 is dissimilar to (5) the case where manual is not checked. Further, the motion determination unit 228 determines whether or not the motion of the user detected by the motion detection unit 224 is dissimilar to (6) the case where the operation result is dissimilar to the content of the manual. Further, the motion determination unit 228 determines whether or not (7) the operation speed of the motion of the user detected by the motion detection unit 224 is too fast.

the motion of the user can be determined, for example, by a method described below, as a method of determining whether or not the motion of the user is dissimilar to (5) the case where the manual is not checked.

For example, the motion detection unit 224 detects the time during which the line of sight of the user is located in the vicinity of the manual as the motion of the user. Then, in a case where the time during which the line of sight of the user, detected by the motion detection unit 224, is located in the vicinity of the manual is shorter than a predetermined time, the motion determination unit 228 determines that the manual is not checked, and determines that they are dissimilar to each other. Further, in a case where the time during which the line of sight of the user, detected by the motion detection unit 224, is located in the vicinity of the manual is equal to or longer than a predetermined time, the motion determination unit 228 determines that the manual is checked, and determines that they are similar to each other. In a case where it is determined that the manual is checked, the motion determination unit 228 acquires the operation position of the user with respect to the operation target, and acquires the gaze position of the user detected by the line-of-sight detection unit 22, by using the line-of-sight sensor 12. Then, the motion determination unit 228 stores the combination of the acquired operation position and gaze position in the data storage unit 230 as calibration data.

the motion of the user can be determined, for example, by a method described below, as a method of determining whether or not (6) the operation result is dissimilar to the content of the manual.

For example, the motion detection unit 224 determines whether or not the image of the operation target representing the operation result is dissimilar to the content of the manual, based on the image of the operation target imaged by the camera 17. The content of the manual is stored, for example, as an image in advance in the storage unit or the like, and the feature amount extracted from the image stored in the storage unit or the like is compared with the feature amount extracted from the image of the operation target to determine whether or not the operation result is dissimilar to the content of the manual. In a case where the operation result and the contents of the manual match each other or are similar to each other, the motion determination unit 228 acquires the operation position of the user with respect to the operation target, and acquires the gaze position of the user detected by the line-of-sight detection unit 22, by using the line-of-sight sensor 12. Then, the motion determination unit 228 stores the combination of the acquired operation position and gaze position in the data storage unit 230 as calibration data.

the motion of the user can be determined, for example, by a method described below, as a method of determining whether or not the motion of the user is dissimilar to (7) the case where the operation speed is too fast.

For example, the motion detection unit 224 determines whether the speed of a change in the image of the operation target is greater than a predetermined threshold, based on the image of the operation target imaged by the camera 17. Then, in a case where it is determined that the speed of change of the image of the operation target is equal to or less than the predetermined threshold, the motion determination unit 228 determines that the operation speed is dissimilar to the case where the operation speed is too fast, and acquires the operation position of the user on the operation target and the gaze position of the user detected by the line-of-sight detection unit 22. Then, the motion determination unit 228 stores the combination of the acquired operation position and gaze position in the data storage unit 230 as calibration data.

Further, in the first to fifth embodiments, the case where the calibration is performed in real time every time the gaze position of the user and the operation position are acquired has been described as an example, but the present disclosure is not limited thereto. For example, the calibration process may be performed at a predetermined timing after obtaining a plurality of calibration data.

Further, in the sixth embodiment, the case where the calibration process is performed at the predetermined timing after the acquisition of the calibration data has been described as an example, but the present disclosure is not limited thereto. For example, the calibration may be performed in real time, each time the gaze position of the user and the operation position are acquired.

In the sixth embodiment, the case where one of the calibration methods by parallel movement and projective transformation is selected according to the number of calibration data pieces has been described as an example, but the calibration method is not limited thereto. The number of calculable coefficients included in the equation used for the calibration is different depending on the number of available calibration data pieces. Therefore, for example, a calibration method using an equation with a larger number of coefficients may be selected as the number of calibration data pieces increases, and a calibration method using an equation with a smaller number of coefficients may be selected as the number of calibration data pieces is reduced.

Further, in each of the above-described embodiments, the case where only the data of the gaze position and the operation position (calibration data) used for the calibration is stored in the data storage unit has been described as an example, but the present disclosure is not limited thereto. For example, all of the detected gaze position and operation position may be stored in the data storage unit, and a flag may be assigned to the data used for the calibration.

In addition, in each of the above-described embodiments, the case where the gaze position is acquired by the line-of-sight sensor 12 and the line-of-sight detection unit 22 has been described as an example, but the present disclosure is not limited thereto. For example, the line-of-sight sensor 12 also has the function of the line-of-sight detection unit 22, and the calibration unit 18 may acquire the gaze position output from the line-of-sight sensor 12.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a calibration program, which when executed by a computer, causes the computer to execute a process, the process comprising:
detecting an operation of a user for a display screen of an information processing device;
determining whether the detected operation corresponds to a predetermined operation stored in a memory, the predetermined operation being an operation that designates a display position with a predetermined condition;
detecting a display position in the display screen designated by the detected operation, and detecting a gaze position of the user by using a sensor in a case where the detected operation corresponds to the predetermined operation pattern stored in the memory;
associating the detected gaze position detected at a specified timing with the detected display position detected at the specified timing; and
calibrating a gaze position to be detected by the sensor, based on the associated display position and the associated gaze position.

2. The non-transitory computer-readable storage medium according to claim 1, wherein the process further comprises:
storing at least one predetermined operation within the memory, the at least one predetermined operation not being specific to a calibration process.

3. The non-transitory computer-readable storage medium according to claim 2, wherein the predetermined operation is included within a predetermined operation pattern that includes a series of operations, the predetermined operation within the series is identified as an operation with accuracy sufficient for performing calibration.

4. The non-transitory computer-readable storage medium according to claim 3, wherein the predetermined operation includes at least one of a cancellation, confirmation, an operation after an erroneous operation, and an operation that cannot be undone.

5. The non-transitory computer-readable storage medium according to claim 1, wherein the calibrating calibrates such that the associated display position and the associated gaze position match.

6. The non-transitory computer-readable storage medium according to claim 1, wherein the predetermined condition represents an operation with accuracy sufficient for performing calibration.

7. The non-transitory computer-readable storage medium according to claim 6, wherein the predetermined condition includes at least one of a cancellation, confirmation, an operation after an erroneous operation, and an operation that cannot be undone.

8. The non-transitory computer-readable storage medium according to claim 1, wherein the detected display position is plane coordinates of a display of the information processing device.

9. The non-transitory computer-readable storage medium according to claim 1, wherein the detected display position of the user represent coordinates within a real or virtual environment relating to a target object being manipulated by the operation of the user.

10. The non-transitory computer-readable storage medium according to claim 1, wherein the process further comprises:
calculating a distance between the display position and the gaze position;
comparing the calculated distance to a threshold; and
canceling the calibrating when the calculated distance is greater than the threshold.

11. The non-transitory computer-readable storage medium according to claim 1,
wherein a carefulness degree representing a degree of carefulness of the detected operation is calculated, based on at least one of the detected operation, the predetermined operation, and the display position and the gaze position, and
parameters to be used for the calibration are selected based on the carefulness degree.

12. The non-transitory computer-readable storage medium according to claim 1, wherein the process further comprises:
detecting sound information from the user, the detected sound information is used in connection with the detected operation and the predetermined operation.

13. The non-transitory computer-readable storage medium according to claim 1,
wherein the detecting the operation of the user includes tracking the gaze position of the user over time.

14. The non-transitory computer-readable storage medium according to claim 1, further comprising:
specifying the user;
acquiring the display position and the gaze position corresponding to the specified user, from a memory in which the display position and gaze position, which are detected, are stored for each user; and
calibrating the gaze position to be detected by the sensor, based on the display position and the gaze position which are acquired.

15. The non-transitory computer-readable storage medium according to claim 1,
wherein the process comprises:
performing the detecting continuously during a predetermined period;
storing one or more the associated display positions and the associated gaze positions in a memory; and
selecting a calibration method for performing the calibration among from a plurality of calibration methods according to a number of the associated display positions or a number of the associated gaze positions stored in the memory during the predetermined period.

16. A calibration device comprising:
a memory configured to store at least one predetermined operation pattern of a user of an information processing device within the memory, the at least one predetermined operation pattern not being specific to a calibration process;
at least one sensor configured to detect an operation of a user using an information processing device and a gaze position of the user; and
a processor coupled to the memory and the at least one sensor, the processor configured to:
determine whether or not the detected operation corresponds to a predetermined operation pattern stored in the memory, in a case where the detected operation corresponds to the predetermined motion;
detect an operation position designated by the user, and detects the gaze position of the user based information detected by the at least one sensor; and
calibrate the gaze position to be detected by the at least one sensor, based on the detected operation position and the detected gaze position.

17. A calibration method executed by an information processing device comprising:
detecting an operation of a user for a display screen of an information processing device;
determining whether the detected operation corresponds to a predetermined operation stored in a memory, the predetermined operation being an operation that designates a display position with a predetermined condition;
detecting a display position in the display screen designated by the detected operation, and detecting a gaze position of the user by using a sensor in a case where the detected operation corresponds to the predetermined operation pattern stored in the memory;
associating the detected gaze position detected at a specified timing with the detected display position detected at the specified timing; and
calibrating a gaze position to be detected by the sensor, based on the associated display position and the associated gaze position.
